(19) United States
(12) Patent Application Publication
(10) Pub. No.: US 2023/0222159 A1
(43) Pub. Date: Jul. 13, 2023

(54) STRUCTURING AUDIO SESSION DATA WITH INDEPENDENTLY QUERYABLE SEGMENTS FOR EFFICIENT DETERMINATION OF HIGH VALUE CONTENT AND/OR GENERATION OF RECOMBINANT CONTENT

(71) Applicant: Solvv Inc., Vancouver, WA (US)

(72) Inventors: KELLY MAX ANSEL ELSASSER, Vancouver, WA (US); Barbara Regula Frei, Vancouver, WA (US)

(21) Appl. No.: 17/574,066

(22) Filed: Jan. 12, 2022

(51) Int. Cl. G06F 16/683; G10L 15/26; G06F 16/68; G06F 16/635; G06F 16/632

(52) U.S. Cl. CPC G06F 16/685; G06F 16/632; G06F 16/635; G06F 16/686; G10L 15/26

(57) ABSTRACT

This disclosure relates generally to data processing devices and, more particularly, to a method, a device, and/or a system of structuring audio session data with independently queryable segments for efficient determination of high value content and/or generation of recombinant content. In one embodiment, a system for analyzing use of audio files to determine high value content includes a database server storing a data container referencing a segment data comprising an audio data and a segment UID that is independently addressable with a database query. A playback manager receives a playback request and streams the audio data to a device of a user. An interest marker engine receives an interest notification including a first audio time point and a second audio time point and generates an interest marker. An analytics server then generates an insight data from the interest marker and stores the insight data in association with the segment data.

### FIELD OF TECHNOLOGY

This disclosure relates generally to data processing devices and, more particularly, to a method, a device, and/or a system of structuring audio session data with independently queryable segments for efficient determination of high value content and/or generation of recombinant content.

### BACKGROUND

Creation and consumption of audio recordings have grown rapidly since the development of digital recording, first due to personal computers and the internet, and then further through widespread distribution of smartphones and broadband connections driving streaming networks. Among the most popular audio files generated and/or consumed include spoken content such as interviews, talks, and debates. Hundreds of digital audio distribution and/or “podcasting” platforms may have arisen over the last two decades, giving rise to many thousands of content channels and millions of audio recordings generated by both amateur and professional users. At the same time, content, and data related to its use have become a valuable asset of both creators and businesses that operate distribution platforms.

Excellent audio content, high audience engagement, and rich data are of increasing value in audio recording generation and consumption, and a platform offering these attributes may have a substantial competitive advantage in the marketplace.

Specifically, it is desirable for invention of new technologies that: promote flexibility in content generation and use; create succinct, high value content; promote continued use and consumption of older content that remains relevant, insightful, or timely; accrue value in the distribution platform while also providing value to creators; and/or identify the most valuable portion of a recording that could drive the creation or consumption of additional content.

### SUMMARY

Disclosed are a method, a device, and/or a system of structuring audio session data with independently queryable segments for efficient determination of high value content and/or generation of recombinant content.

One embodiment is a method for structuring audio recordings to identify high value content. The method generates in a computer readable memory a data container for storing data of an audio session and assigns a container UID to the data container. The method authenticates a first user associated with a first user profile and a second user associated with a second user profile. A first audio data is received from a device of the first user over a network and the first audio data is stored in a first segment data. A first segment UID is assigned to the first segment data. The first segment UID is independently addressable from the container UID with a database query. Similarly, a second audio data is received from a device of the second user over the network, and the second audio data is stored in a second segment data. A second segment UID is assigned to the second segment data. The second segment UID is independently addressable from the container UID and the first segment UID of the first segment data with the database query. The method then associates the first segment data with the data container through a first reference attribute and also associates the second segment data with the data container through a second reference attribute. The resulting structure enables high value content to be efficiently attributed to the first user, the second user, the first segment data, and/or the second segment data.

The method may apply a speech recognition software to the first segment data to generate a text data. The text data may be associated with the first segment. An audio time may be mapped to a text location within the text data.

The method may receive a playback request from a device of a third user (e.g., a consumer). The playback request may include the container UID of the data container and/or the first segment UID of the first segment data. The audio data and/or text data of first segment data is then streamed to the device of the third user.

A first interest notification received from the device of the third user may include the first segment UID of the first segment data, a first audio time point and a second audio time point. The method may generate a first interest marker that includes the first segment UID of the first segment data, the first audio time point, and the second audio time point. The first interest marker may be stored in association with the user UID of the third user. Optionally, the first interest marker may also be stored in association with the container UID of the data container, the first segment UID of the first segment data, and/or the user UID of a fourth user generating the first audio data.

Alternatively, the method may receive a first interest notification from a device of a third user, where the interest notification include the first segment UID of the first segment data and an audio time point and/or an audio time range. A first text content may be determined that is a word, a phrase, and/or a sentence within the text data that corresponds to the audio time point and/or the audio time range. The method may then generate an interest marker specifying the first text content, and store the interest marker in association with a user UID of the third user. The interest marker may optionally be stored in association with the container UID of the data container, the container UID of the first segment data, and/or a user UID of a fourth user generating the first audio data (e.g., a panelist or moderator whose voice is recorded in the first audio data).

The method may generate a second interest marker from a second interest notification received from a device of a fifth user having generated a second playback request. It may be determined above a threshold probability that the first interest marker and the second interest marker associated with a second text content are both directed to a third text content. The third text content is at least partially outside at least one of a first text content and/or the second text content.

The method may then generate an insight data to specify the third text content. The insight data includes the third text content, data specifying a text location of the third text content within a text data, a portion of the first audio data (e.g., an audio clip), and/or data specifying an audio location of an audio clip within the first audio data of the first segment data. The insight data may be stored in association with the container UID of the data container and/or the first segment UID of the first segment data.

The method may also extract the third text content of the insight data and authorize access through the API to the third text content of the insight data by an API key controlled by the first user. A remote procedure call from a social media network may then be responded to by transmitting the first text content. Dynamic updating of the insight data may occur upon receiving a third interest marker and determining above the threshold probability that the first interest marker, the second interest marker, and the third interest marker are directed to a fourth text content.

A selection of a content instruction may be received for generating the first audio data. The content instruction may be a text string that includes a discussion topic, a debate motion, and/or a discussion prompt. The content instruction may be associated with the data container and indexing the content instruction in a database. A time overlay of the text data may be stored in association with the first segment data, wherein at least two characters of the text data are associated with at least two audio time points of the first segment data. A subject designation may be received from the first user and/or the second user. The method may then associate the subject data with the data container.

Another embodiment is a method for generating audio recordings for efficient content remixing. The method includes receiving a session request for creation of an audio session from a device of a first user. The session request includes a user UID of the first user and a content instruction for generating an audio recording for the audio session. A first data container is generated within a session database to receive data from the audio session, and a container UID is assigned to the first data container.

The method specifies a session format data that includes a panelist number, a panelist criteria, and/or a segment composition that includes a plurality of segments each having a time allocation. A panelist role is designated for a user profile of each of two or more users to define two or more panelist users. Each of the two or more panelist users are then assigned to at least one of the plurality of segments.

The method receives a set of audio streams from the two or more panelist users for each of the plurality of segments, and stores a set of audio data within a set of segment data. Each segment data is assigned a segment UID and each is associated with the first data container through a reference attribute. The set of audio data includes a first audio data.

The method may query the session database for one or more data containers that include at least one of the content instruction and a subject data. The container UID of the first data container and a container UID of a second data container may be returned. A first segment UID of a first segment data may be extracted from the set of segment data of the first data container, and similarly a second segment UID of a second segment data may be extracted from the second data container. A third data container may be assembled, including (i) the content instruction and/or the subject data, (ii) the first segment UID of first segment data, and (iii) the segment UID of the second segment data. As a result, a podcast file with new opportunities for comparative insight and analysis may be generated.

A moderator role may be designated for a first user profile of the first user to define a moderator user. A segment attenuation instruction may be received for a first audio stream of the set of audio streams, the segment attenuation instruction generated by the moderator user and/or a panelist user of the two or more panelist users. Storage may be initiated for a second audio data generated from the set of audio streams in a second segment data. The method may dynamically reallocate the session format data through at least one of: changing the panelist number, adjusting the panelist criteria, adjusting the segment composition, and/or adjusting the time allocation of one or more of the plurality of segments.

The method may also apply a speech recognition software to the first segment data to generate a text data and associate the text data with the first segment data. A map may be determined between an audio time point of the first audio data and a text location within the text data. A playback request may be received from a device of a third user. The playback request may include the container UID of the first data container and/or the first segment UID of the first segment data. The first audio data of the first segment data and/or the text data of the first segment data may be streamed to the device of the third user.

A first interest notification from the device of the third user may be received, the first interest notification including the segment UID of the first segment data and at least one audio time point and/or audio time range. It may be determined that a first text content that is a word, a clause, and/or a sentence within the text data corresponds to the audio time point and/or the audio time range.

A first interest marker specifying the first text content may be generated and stored in association with a user UID of the third user. The first interest marker may also optionally be stored in association with the container UID of the first data container, the container UID of the first segment data, and/or a user UID of a fourth user generating the first audio data. The insight data may then be indexed in a database.

A second interest marker may be generated from a second interest notification received from a device of a fifth user having generated a second playback request. It may be determined above a threshold probability that the first interest marker and the second interest marker associated with a second text content are both directed to a third text content that is at least partially outside a text location of the first text content and/or a text location of the second text content.

An insight data may be generated specifying the third text content. The insight data includes the third text content, data specifying a text location of the third text content in the text data, a portion of the first audio data, and/or data specifying an audio location of an audio clip within the first audio data of the first segment data. The insight data may be stored in association with the container UID of the first data container and/or the container UID of the first segment data.

In yet another embodiment, a system for analyzing use of audio files to determine high value content includes a coordination server, a database server, an analytics server, and a network communicatively coupling the coordination server to the database server and the analytics server.

The database server stores a data container. The data container includes a container UID, a first segment data having a first segment UID, and a second segment data having a second segment UID. The first segment data includes a first audio data. The first segment UID, the second segment UID, and the container UID are each independently addressable with a database query.

The coordination server includes a processor, a memory, a playback manager, and an interest marker engine. The playback manager includes computer readable instructions that when executed: receive a playback request received from a device of a first user (the playback request comprising the container UID of the data container) and stream the first audio data of the first segment data to the device of the first user. The interest marker engine including computer readable instructions that when executed receive a first interest notification from the device of the first user. The interest notification includes the first segment UID of the first segment data, a first audio time point and a second audio time point. The interest marker engine further includes computer readable instructions that when executed (i) generate a first interest marker that includes the first segment UID of the first segment data, the first audio time point, and the second audio time point, and (ii) store the first interest marker in association with a user UID of the first user.

The analytics server includes computer readable instructions that when executed generate an insight data from the first interest marker, and then store the insight data in association with the container UID of the data container, the first segment UID of the first segment data, and/or the user UID of a second user generating an audio data of the first segment data.

The interest marker engine may include computer readable instructions that when executed generate a second interest marker from a second interest notification received from a device of a third user having generated a second playback request. The analytics server may further include computer readable instructions that when executed determine above a threshold probability that the first interest marker, and the second interest marker associated with a second text content, are both directed to a third text content that is at least partially outside at least one of a first text content identified by the first interest marker and/or the second text content identified by the second interest marker. The analytics server may further include computer readable instructions that when executed generate an insight data specifying the third text content and store the insight data in association with at least one of the container UID of the data container and/or the first segment UID of the first segment data. The insight data may include the third text content, data specifying a text location of the third text content within a text data, a portion of the first audio data, and/or data specifying an audio location within the first audio data of the first segment data.

The coordination server may further include an inter-content extraction routine and an extraction content API. The inter-content extraction routine may include computer readable instructions that when executed: (i) extract the third text content of the insight data, (ii) associate the third text content with the data container, and (iii) authorize access through an API to the first text content of the first interest marker by an API key controlled by the first user. The inter-content extraction routine may also include computer readable instructions that when executed respond to a remote procedure call from a social media network by transmitting the first text content, and dynamically update the insight data upon receiving a third interest marker and determining above the threshold probability that the first interest marker, the second interest marker, and the third interest marker are directed to a fourth text content.

The analytics server may further include an audio/text alignment engine that includes computer readable instructions that when executed store a time overlay of the text data in association with the first segment data. In the time overlay, at least two characters of the text data may be associated with at least two audio time points of the first segment data.

The system may also include a session synthesis engine. The session synthases engine may include computer readable instructions that when executed query a session database for one or more data containers comprising a content instruction and/or a subject data and return the container UID of the data container and a container UID of a second data container. The session synthases engine may include computer readable instructions that when executed (i) extract the first segment UID of the first segment data from a set of segment data associated with the data container; (ii) extract the second segment UID of the second segment data from the second data container; and (iii) assemble a third data container. The third data container may include: (i) the content instruction and the subject data, (ii) the first segment UID of first segment data, and/or (iii) the second segment UID of the second segment data. The result may include a podcast file with new opportunities for comparative insight and analysis.

The system may also include a container management routine. The container management routine may include computer readable instructions that when executed: (i) generate the data container for storing data of an audio session, (ii) assign the container UID to the data container, (iii) generate the first segment data, (iv) assign the first segment UID to the first segment data that is independently addressable from the container UID with the database query, (v) generate the second segment data, and (vi) assign the second segment UID to the second segment data that is independently addressable from the container UID and the first segment UID of the first segment data with the database query.

The system may also include a segment association subroutine that may include computer readable instructions that when executed associate both the first segment data with the data container through a first reference attribute and the second segment data with the data container through a second reference attribute.

A session initiation module may be included within the system, and may comprise computer readable instructions that when executed receive a session request for creation of the audio session from the device of the first user. The session request may include the user UID of the first user and a content instruction for generating an audio recording for the audio session. The session initiation module may also include computer readable instructions that when executed generate the data container within the session database to receive data from the audio session and assigning the container UID to the data container. A format allocation routine may include computer readable instructions that when executed specify a session format data including a panelist number, a panelist criteria, and/or a segment composition. The segment composition includes a plurality of segments each having a time allocation. A role allocation module of the system may include computer readable instructions that when executed designate a panelist role for a user profile of each of two or more users to define two or more panelist users, and assign each of the two or more panelist users to at least one of the plurality of segments.

### BRIEF DESCRIPTION OF THE DRAWINGS

The embodiments of this disclosure are illustrated by way of example and not limitation in the figures of the accompanying drawings, in which like references indicate similar elements and in which:

FIG. 1.1 illustrates a structured audio data network including a coordination server, a database server, an analytics server, a profile server, a first set of devices generating audio recordings (e.g., from a first set of users that may include for example a moderator and one or more panelists) and a second set of devices consuming audio recordings and transmitting interest notifications usable for generation of insight data, according to one or more embodiments.

FIG. 1.2 illustrates a first data structure usable for storing audio recordings and related data, including a set of segment data each generated in association with one or more user profiles, a data container referencing one or more instances of the segment data that share a common characteristic (e.g., generated in association with a single audio session), a subject UID usable to group data containers, and different instances of segment data that are each referenced by different data containers usable to generate a new data container, referred to as a recombinant instance of the data container, according to one or more embodiments.

FIG. 1.3 illustrates a second data structure including database references drawn between the segment data and the data container, database references drawn between the segment data and a first user profile associated with generating the segment data, and further illustrating a second user profile and a third user profile generating interest markers usable to produce an insight data that may be associated through a reference drawn to the segment data, according to one or more embodiments.

FIG. 1.4 illustrates a third data structure including attributes and/or values of the segment data, the data container, and the insight data of FIG. 1.3, the segment data storing one or more audio data and/or text data that may be a transcript, and one or more instances of the insight data, where the insight data includes an audio clip of a portion of the audio data and/or a text content of a portion of the text data, according to one or more embodiments.

FIG. 2 illustrates a coordination server, including an authentication system, a session management engine for setting up and managing audio sessions and associated data structures, and an interest marker engine for processing interest notifications transmitted by users consuming audio recordings and/or transcripts, according to one or more embodiments.

FIG. 3 illustrates a database server including a content database storing one or more data structures (e.g., the data structure of FIG. 1.2 through FIG. 1.4), a segment identifier subroutine for uniquely identifying segment data, an inter-content engine enabling API access to content extracted from one or more segment data, and a set of indexes to assist in locating content by subject, content creation instruction, and/or insight, according to one or more embodiments.

FIG. 4 illustrates an analytics server including a speech recognition engine for transcribing the text data from the audio data, a voice recognition routine, an audio/text alignment engine, and an insight data generation engine usable to convert interest of users consuming audio data into insight for an audio platform and/or users generating the audio data, according to one or more embodiments.

FIG. 5 illustrates a profile server, including a profile database storing a user profile that may include a content listing of each segment data to which the user profile is associated, an interest listing including one or more insight data generated from insight notifications as a result of audio file consumption, and an insight listing including a reference to one or more insight data generated from the segment data within the content listing, for example the most insightful portions (as found by consumers) of the user’s own audio content, according to one or more embodiments.

FIG. 6 illustrates a device, such as a personal computer or smartphone, usable to initiation audio sessions, control audio sessions, generate audio data, consume insight data, and/or generate interest notifications for production of interest markers, according to one or more embodiments.

FIG. 7 illustrates session initiation process flow, according to one or more embodiments.

FIG. 8 illustrates a data structure assembly process flow, according to one or more embodiments.

FIG. 9A illustrates an interest marker generation process flow illustrating generation of interest markers designated by users consuming audio recordings, the interest markers usable as a raw material for production of insight data, according to one or more embodiments.

FIG. 9B illustrates another interest marker generation process flow, including use of text data in defining the interest marker, according to one or more embodiments.

FIG. 10 illustrates an insight data generation process flow for determining a portion of the audio recording representing content having a high probability of being insightful to an audience and/or being independently usable content outside the original audio session, according to one or more embodiments.

FIG. 11 illustrates an insight extraction and access process flow for extracting insight data and/or additional content from a segment data and making it accessable through an application programming interface, including for example automatic upload to a social media network server to highlight insights resulting from content of a user, according to one or more embodiments.

FIG. 12 illustrates a recombinant audio process flow enabling assembly of related and/or contextually relevant audio recordings from two or more segment data associated with two or more different container data to create new content for consumption and/or generation of new interest and/or insight, according to one or more embodiments.

FIG. 13 illustrates an example embodiment in which a moderator and two panelists record a podcast that includes seven segments, two consuming users then listening to the podcast and identifying areas of interest, stored as interest markers, the interest markers then used to generate an insight data including an audio clip and/or text content that may be independently valuable, accessible (e.g., via API), or otherwise leveraged by a distribution platform and/or one or more users of the distribution platform, according to one or more embodiments.

Other features of the present embodiments will be apparent from the accompanying drawings and from the detailed description that follows.

### DETAILED DESCRIPTION

Disclosed are a method, a device, and/or system of structuring audio session data with independently queryable segments for efficient determination of high value content and/or generation of recombinant content. Although the present embodiments have been described with reference to specific example embodiments, it will be evident that various modifications and changes may be made to these embodiments without departing from the broader spirit and scope of the various embodiments.

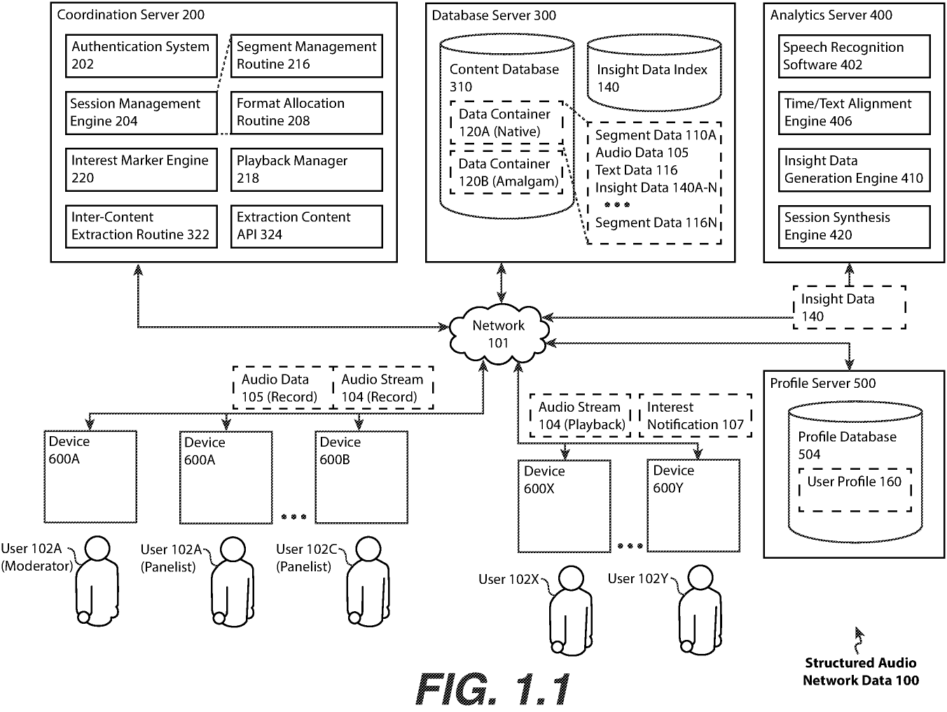

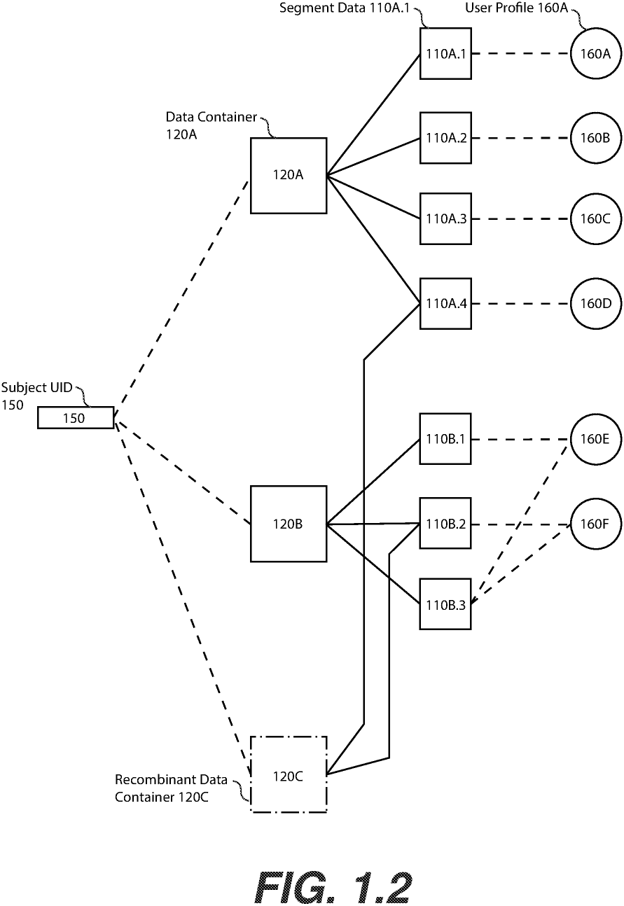

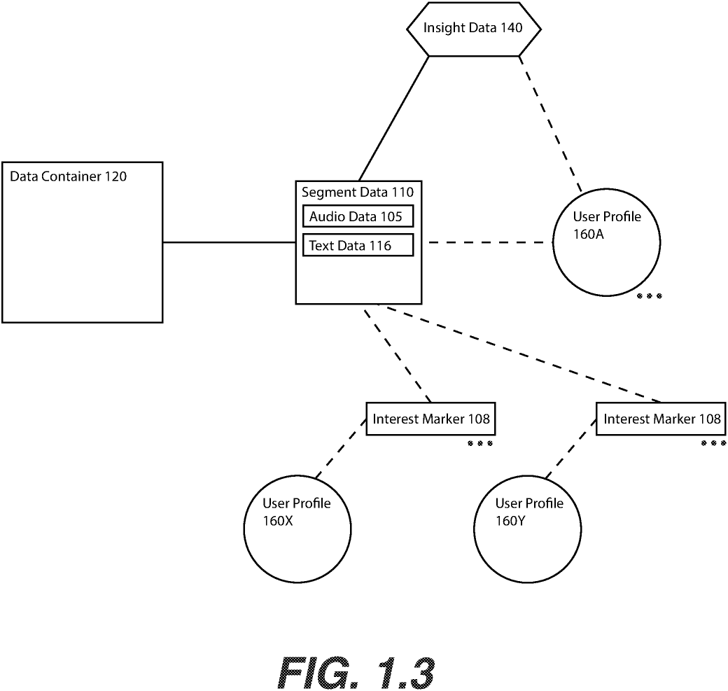

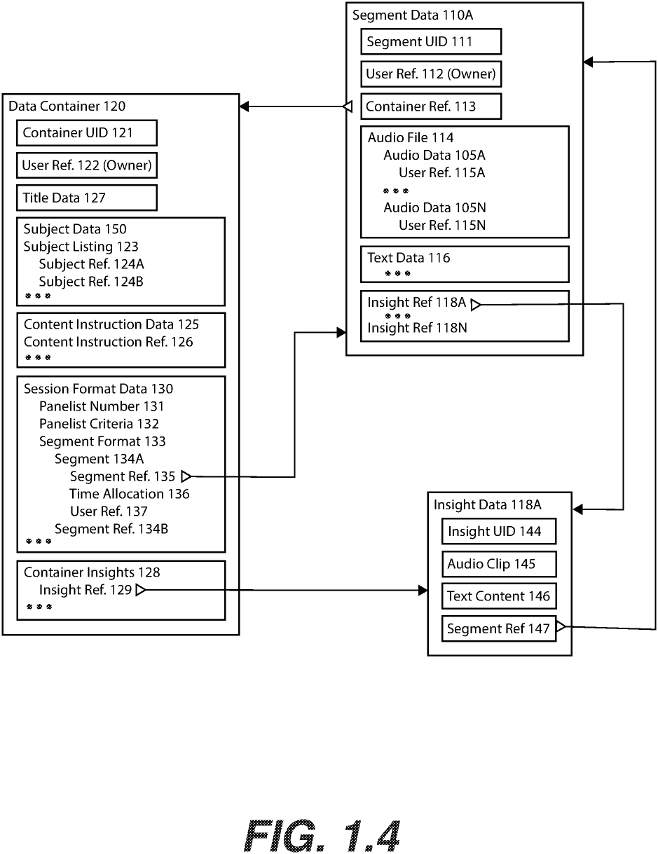

FIG. 1.1 illustrates a structured audio data network 100, according to one or more embodiments. In one or more embodiments, the structured audio data network 100 may be utilized format, record, organize, and/or structure audio recordings, including to enhance and/or enable the ability to rebuild, remix, and derive new insight from audio recordings and/or transcripts, as shown and described throughout the present disclosure. In one or more embodiments, the structured audio data network 100 may be utilized to record audio streams 104 from two or more users 102 to be stored as audio data 105 according to a static and/or dynamic format that enhance and/or enable the ability to rebuild, remix, and derive new insight from audio recordings. The two or more users 102, for example, may include a moderator and a set of panelists. In one or more embodiments, the structured audio data network 100 may be utilized to distribute audio recordings to users for consumption, listening, and/or interactive participation, including recording and logging interest each use may have in various portions of the audio recordings usable for further analysis. In one or more embodiments, the structured audio data network 100 may be utilized to determine content within the audio recordings that may be of high value, and further to generate insight data which may have independent identity and value apart from the audio recording. For example, the insight data 140 may be automatically attributed to a user 102 generating the audio recording from which it derives, the insight data 140 may be published to social media servers to assist in communications and marketing, and/or the insight data 140 may be used for other purposes. In one or more embodiments, the structured audio data network 100 may be utilized to synthesize new content from structured audio recordings and additional associated data, a capability which may refresh the value of the audio recordings and/or their transcripts. Other advantages will be evident to one skilled in the art of software engineering, sound engineering, audio recording, cloud computing architectures, and other technological disciplines.

In one or more embodiments, a set of one or more devices 600 may be utilized to generate an audio data 105. Each device 600, for example, may be a personal computer, smartphone, or tablet each associated with a user 102. Specifically, as just one example shown in FIG. 1.1, a device 600A may be associated with a user 102A which may act as a moderator for an audio session, and there may be a device 600B may be associated with a user 102B who may act as a first panelist of the audio session, and a device 600N may be associated with a user 102N who may act as a second panelist of the audio session. One or more audio streams 104 may be generated for the audio session and communicated over a network 101 to a coordination server 200. The network 101 may be a communication network such as a local area network (LAN), a wide area network (WAN), and/or the internet. Although for clarity a single audio stream 104 is illustrated, each device 600 may generate one or more discrete audio streams 104 throughout the course of the audio session and according to a static and/or dynamic session format and then stored as audio data 105, as further shown and described throughout the present embodiments. Alternatively, or in addition, the audio data 105 may be recorded on the device 600 and uploaded.

In one or more embodiments, the audio session may be set up according to a static format and/or a dynamic format, for example by the user 102A acting as the moderator, or one or more other users 102. The audio session may be setup and/or formatted through communications between one or more devices 600 and the coordination server 200 over the network 101. A session management engine 204 may be utilized to structure the audio session, as further described throughout the present embodiments. As just one example, the audio session may include: (i) a subject data 123 providing a subject of the audio session and/or content instruction data 125 (e.g., as shown in FIG. 1.4) providing a prompt, theme, subject and/or topic, and (ii) a session format data 130 that may specify the number of participating users 102 (including roles such as panelists) and/or the time allocation 136 of a set of two or more segments. The content instruction data 125 may include a content instruction that is a text string (e.g., textual data in a string format).

In one or more embodiments, following initiation of the audio session, each of the audio streams 104 may be received by and/or processed by the coordination server 200. A segment management routine 216 may process, structure, and/or store each audio stream 104 as a set of audio data 105 (and/or receive uploads of audio data 105), as further shown and described throughout the present embodiments. In one or more embodiments, a data container 120 may be defined for the audio session, where each segment is individually processed and stored in a segment data 110 that may be uniquely identified and/or individually addressable. Examples of the data container 120, the segment data 110, and their potential associations are further shown and described in the data structure embodiments of FIG. 1.2 through FIG. 1.4.

Upon completion of the audio session (or in realtime, as described below), audio recordings may have been structured and stored in a content database 310 as a data container 120 (e.g., the data container 120A) along with one or more segment data 110 (e.g., the segment data 110A through the segment data 110N). The content database 310, for example, may be stored on a database server 300.

In one or more embodiments, additional processing of the data of the audio session may occur in real-time and/or after completion of the audio session (e.g., “post-processing”), as described throughout the present embodiments. However, in one or more embodiments, a speech recognition software 402 may be optionally employed to generate a text data 116 corresponding to the audio data 105. The text data 116 may be a transcript of the audio data 105. The speech recognition software 402 may be accessible by remote procedure call to an analytics server 400, as further shown and described below. Additional processing may include the separation of the voices of each user 102 recorded within audio data 105, for example where two or more users 102 that are acting as panelists and/or moderators are speaking within the same audio data 105 of a segment data 110. In such case the text data 116 may distinguish individual users 102. The text data 116 may be used for consumption by itself or in combination with the audio data 105. For example, the text data 116 may be transmitted to a user 102 who is listening to the associated audio recording. The text data 116 also may be utilized in the curation and/or identification of interest markers 108 and/or insight data 140, as further shown and described thorough the present embodiments.

The data container 120A and/or each of the associated segment data 110A through segment data 110N may be consumable, for example subject to playback and/or interaction by a set of users 102 that may collectively form an audience (e.g., the user 102X and the user 102Y as shown in FIG. 1.1). The set of users 102 collectively forming the audience may individually download and/or stream the audio data 105 on devices 600 (e.g., as shown in FIG. 1.1, the device 600X and the device 600Y). As just a few examples, the data container 102 may include audio data 105 of each segment data 110 that together make up an audio session that may be a podcast, a debate, a public hearing, and/or panelists each speaking to a common topic, question, and/or theme. The audio data 105 may be playable on a software application running on the device 600, for example a desktop application (e.g., a Windows® program) and/or a mobile application (e.g., iOS® App, Android® App).

In one or more embodiments, a user 102 consuming an audio recording may engage in one or more interactions that may be logged as data and transmitted to one or more of the servers illustrated in FIG. 1.1 (e.g., the coordination server 200, the database server 300, the analytics server 400, and/or the profile server 500). One type of consumer interaction may be to generate an interest notification 107 specifying a portion of an audio recording in which the user 102 is expressing interest. For example, the expressed interest nay relate to personal favorite content, content for follow up research, content to be fact-checked, and/or otherwise notable content. The interest notification 107 may be generated through the software application running on the device 600 such as the mobile application. For example, the user interface of the software application may permit the selection of a portion of the audio data 105 through selecting points on a visual waveform. The waveform may be presented on a GUI and include markup, playback times, and other visual cues to assist the selection. In another example, selections may occur on an accompanying transcript of the audio data 105, e.g., the text data 116 transmitted to the user 102 consuming the audio data 105.

In one or more embodiments, the interest notifications 107 may be processed by one or more of the servers of FIG. 1.1 and utilized to generate an interest marker 108. The interest marker 108 may be stored in, and/or in association with, a user profile 160 of a user 102 generating the interest notification 107. For example, the user profile 160 may include a plurality of interest markers 108 referencing one or more data containers 102 and/or segment data 110. The interest markers 108 may be retrievable by the user 102 through the software application on the device 600, for example for review, refinement, editing, and/or deletion. From the perspective of the user 102 consuming audio recordings, this may enable or enhance: distribution platform interaction; content interaction and “active listening”; the ability to find and recall favorite content; the ability to find favorite portion of content; the ability to bookmark content that is personally important to that user 102; and/or create annotations and personal analysis.

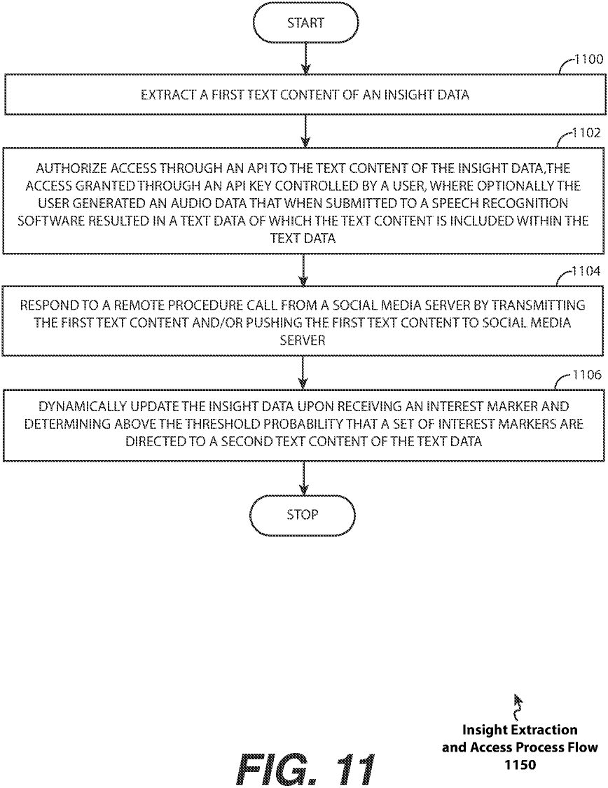

In one or more embodiments, the interest markers 108 generated from two or more users 102 (e.g., the user 102X and the user 102Y) may be automatically analyzed to identify what may be high-value content. For example, the high-value content may be content that is most likely for to be found insightful by an audience (e.g., a new technique for carrying out a task, wisdom to live by), to generate an action or reaction (e.g., join a cause, change a personal behavior, change a corporate practice), and/or to stimulate additional interest in a subject, moderator, or panelist (e.g., subscribe to a channel, look up a book title). Such high value content may be identified, extracted, and/or stored as an insight data 140. In one or more embodiments, an insight data generation engine 410 generates and extracts the insight data 140. One or more database references may link the insight data 140 to a segment data 110 and/or a user profile 160, each of which may be stored in the content database 310 and/or other databases. The insight data 140 may be independently identified and/or addressable, may be independently transmittable and/or accessible (including through an API), and in one or more embodiments may be used independently of the original audio session, data container 102, and/or segment data 110 from which the insight data 140 was originally derived. For example, the insight data 140 may include an audio clip 145 (e.g., a portion of the audio data 105) and/or a text content 146 (e.g., a portion of the text data 116) that can be pushed to and/or called from a server computer, as further shown and described in conjunction with the embodiment of FIG. 11. In one or more embodiments, this data independence and accessibility can enable evolving and/or realtime high-value content to be broadcast to participants in an event (e.g., a conference), published to a newsfeed used as thumbnails or content selection aids, and/or published on a social media network in association with a social media profile.

In one or more embodiments, the structuring of the data associated with an audio session, including without limitation a possible separation into a data container 102 and segment data 110, may enable and/or promote generation of new content through deliberate reorganization. As further shown and described in the embodiment of FIG. 1.2, one or more segment data 110 originally recorded in disparate audio sessions may be recombined according to a shared data characteristic. Specifically, a session synthesis engine 420 of the analytics server 400 may effect the recombination, in one or more embodiments. The recombinant data may be referred to as a data container 102 that is a recombinant data container, and/or simply a recombinant container. For example, a shared characteristic may be a common subject UID 150, e.g., “automotive repairs.” Another shared characteristic may be a common and/or similar instruction data 125, e.g., “the best ways to avoid holiday stress”, “what was your most numinous experience?” or “the pros and cons of Proposition 6230”. Other examples of common characteristics may be a common user 102 who is acting as a panelist, a common user 102 who is acting as a moderator, common words within an audio recording determined by parsing the audio data 105 and/or text data 116, a frequency of use or interaction (e.g., having the highest number of interest data 108), and/or other data associated with the segment data 110 and/or the associated data container 102.

In one or more embodiments, the recombinant instance of the data container 102 may be pre-generated for presentation to one or more users 102 who may be interested in consuming such content. For example, a subject data 123 for “embarrassing moments” may be a common characteristics utilized to generate a recombinant instance of the data container 102. In such case, the recombinant data container 120 could include five instances of segment data 110 each originally recorded in different audio sessions, but which all demonstrated high relative levels of interest notification 108 within each of the data containers 102 from which they originate. In one or more other embodiments, the recombinant instance of the data container 102 may be generated in response to a query and/or search term of a user 102 (e.g., generated “just-in-time”). For example, a user 102 who intends to consumer an audio recording may be searching for “amazing things in space” and a custom podcast may be assembled for the user 102 using including three segments (e.g., three instances of the segment data 110). The three segments could include an audio data 105 from a user 102 who is an astronomer, an audio data 105 from a user 102 who is an astrophysicist, an audio data 105 from a user 102 who may be an amateur space enthusiast known for science communication to the public. As just one example of the benefits of such custom recombinant content, the user 102 consuming the custom content may be provided with a gateway into different styles of communications, domain-specific languages, approaches for explaining the same question (e.g., each of the astronomer, the astrophysicist, and the lay user answering “what is a black hole?”), and new opportunities to generate interest and/or insight outside the original audio session in which each segment data 110 was generated.

In one or more embodiments, recombinant instances of the data container 120 may also enable context-independent generation of interest markers 108 and/or insight data 140 with respect to a segment data 110. Such interest markers 108 and/or insight data 140 associated with a segment data 110, when identified across multiple instances recombinant instances of the data container 120, may be more likely to be content which is of high value independent of the other segment data 110 of the audio session in which the segment data 110 was originally recorded.

While in one or more embodiments the data of the audio session is described as being stored prior to consumption, playback, generation of interest notifications 107, and/or generation of insight data 140, it should be noted that in one or more other embodiments each of such events may occur in real-time in conjunction with generation of the audio stream 104 (e.g., from a user 102A) and its structuring and/or recording. For example, an audio data 105 may begin to be recorded (e.g., from the audio stream 104), simultaneously transcribed (e.g., by the speech recognition software 402), and with a relatively short latency streamed to a user 102 for listening (e.g., the user 102X). The user 102X may generate interest notifications 107 prior to termination and final storage of the audio data 105, and similar insight data 140 may be able to be generated with relatively small delay provided enough substrate data (e.g., multiple instances of the interest marker 108) may be analyzed. As just one example, a live podcast with several panelists and thousands of simultaneous users 102 listening live may result in near-live identification of high value content that may be broadcast simultaneously with the live podcast or presented on a separate communication channel.

The technology described herein may be used by an audio distribution platform and/or podcasting platform to: enable users 102 to create diverse content, enable users to consume and interact with the content, automatically generate high value content based on consumption and/or interaction (attributing value to both the platform and the users 102 generating the content), and/or to effectively recombine and remix content to test, retain, and/or improve its value. Other features of the present embodiments will be apparent from the accompanying drawings and from the detailed description that follows.

FIG. 1.2 through FIG. 1.4 illustrate data structures that may be utilized to structure, format, and/or store data from audio sessions, audio recordings, transcripts, data created or derived from the foregoing (including interest markers 108 and/or insight data 140), and/or metadata of any of the foregoing.

FIG. 1.2 illustrates a first data structure usable for storing audio recordings and related data, according to one or more embodiments. In one or more embodiments, an audio session may initiate storage of data in a data container 120. The data container 120 may be associated with one or more segments through a database reference, each segment modeled by and storing data in a segment data 110. Each of the segment data 110 may store an audio file 114 comprising one or more audio data 105, each originally received from an audio stream 104 from a device 600 of a user 102. Within the data structure of FIG. 1.2, the segment data 110 may be associated with the user profile 160 of the user 102 generating the audio stream 104 and/or the audio data 105. One or more data containers 120 may each be linked, grouped, and/or referenced by additional data objects, for example a data object representing a subject (e.g., a subject data 150).

Specifically, in the embodiment of FIG. 1.2, a data container 120A may be stored to represent a first audio session. The data container 120A is illustrated with four associated instances of the segment data 110 (the segment data 110A.1 through the segment data 110A.4). Database associations between the data container 120 and each segment data 110 may be effective through a one-way reference or a two-way reference. For example, the data container 120A may reference the segment data 110A.1 through a unique identifier of the segment data 110A.1 (e.g., the segment UID 111 of FIG. 1.4) and/or the segment data 110A.1 may reference the data container 120A through a unique identifier of the data container 120 (e.g., the container UID 121 of FIG. 1.4).

Each segment data 110A may store an audio data 105 (e.g., as shown in FIG. 1.3) generated by a user 102 having an associated user profile 160. For example, a user 102A associated with a user profile 160A may generate the audio file 105 stored in the segment data 110A.1, a user 102B associated with a user profile 160B may generate the audio file 105 stored in the segment data 110A.2, etc. In a further instantiated example, the user profile 160A may be associated with a user 102 acting as a moderator provides an introduction in the segment data 110A.1. Following the introduction, the segment data 110A.2 through the segment data 110A.4 may each store a discussion from a panelist (e.g., the user 102B through the user 102D associated with the user profile 160B through the user profile 160D, respectively).

In the embodiment of FIG. 1.2, a data container 120B may be stored in association with a second audio session. The data container 120A is illustrated with four three instances of the segment data 110 (the segment data 110B.1 through the segment data 110B.3). In this case, the data container 120B might store data of an audio recording in which two users 102 are debating a topic. The segment data 110B.1 may store an audio data 105 of a first opening statement of a user 120E (not shown) associated with the user profile 160E. The segment data 110B.2 may store an audio data 105 of a second opening statement of a user 102F (not shown) associated with a user profile 160F. Finally, the segment data 110B.3 may store an audio file 114 in which two instances of audio data 105 are stored, one generated from an audio stream 104 associated with the user profile 160E and the other generated form an audio steam 104 associated with the user profile 160F. For example, the segment data 110B.3 may store data of a live, real-time debate between the user 102E and the user 102F following both of their opening statements. It should be noted that a moderator is not required for an audio session, in one or more other embodiments.

The data container 120A and the data container 120B may share one or more common characteristics. For example, as shown in FIG. 1.2, both may reference a common instance of the subject data 150. In the present example, the subject data 150 could be “climate change”. The data container 120A might store and/or reference a content instruction data 125 such as “what are the best new ideas to slow climate change?”, whereas the data container 120B may store and/or reference a content instruction data 125 such as “should developing nations be held to the same standards of fossil fuel reduction under the Paris Climate Agreement?”.

As will be shown and described throughout the present embodiments, one or more common characteristics may be usable to generate a recombinant instance of the data container 120. Specifically, FIG. 1.2 further illustrates generation, storage, and structuring of a third data container, the data container 120C based at least in part on a common subject data 150. In addition to the common subject data 150, another common characteristic could be a high number of insight data 140 generated in association with each segment data 110 and/or a common year in which the segment data 110 was generated (e.g., 2022). Within a database, the data container 102C that is a recombinant data container 120 may include a refence to the segment data 110A.4 and the segment data 110B.2. A descriptor analogous to the content instruction data 125 (e.g., a content descriptor data) may be generated, for example, “the most insightful thinkers in climate change, 2022”. As a result, a user 102 consuming the synthesized “audio session” would be able to hear audio records from related but distinct segment data 110. The data container 120C may user-specific (e.g., generated in response to a particular query of a user 102), specialized (e.g., generated and presented to users 102 having certain characteristics, such as a common profession) and/or for widespread consumption (e.g., curated and built for a general audience based on data). The data container 120C may be generated in real-time based on a query and/or may be preassembled and prestored.

FIG. 1.3 illustrates another data structure, including further elaboration on possible content and referential attributes stored in association with the embodiment of FIG. 1.2, according to one or more embodiments. Each of the data objects illustrated in FIG. 1.3 (e.g., the interest marker 108, the segment data 110, the data container 120, the insight data 140, and the user profile 160) may be independently identified (e.g., by unique identifier, by GUID) and/or independently addressable within a database (e.g., the content database 310, the profile database 504, and/or other databases). The data container 120 may reference the segment data 110 and/or the segment data 110 may reference the data container 120. The segment data 110 may reference one or more user profiles 160 (e.g., the user profile 160A through the user profile 160N) of users 102 contributing to an audio data 105 stored within the segment data 110.

The segment data 110 may store an audio data 105 (and/or an audio file 114 comprising one or more instances of the audio data 105 as shown and described in conjunction with FIG. 1.4). In addition, the segment data 110 may also store a text data 116. The text data 116 may be a transcript of the audio data 105 and/or the audio file 114. Additional data that may be stored in and/or referenced by the segment data 110 is shown and described in conjunction with FIG. 1.4.

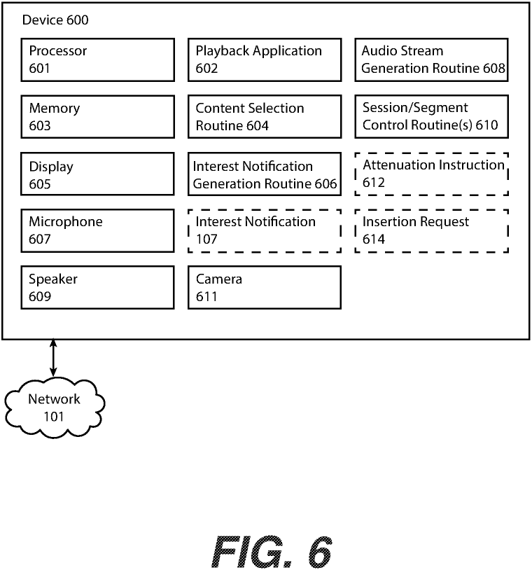

In one or more embodiments, one or more user profile 160 (e.g., the user profile 160X through the user profile 160Y) may initiate generation of interest markers 108 designating a portion of the data stored by the segment data 110. For example, as described in conjunction with the embodiment of FIG. 1.1, an interest marker 108 may be generated from an interest notification 107 originating from a software application on the device 600 of the user 102 consuming audio recording. In one or more embodiments, the interest marker 108 may be stored within and/or in association with the user profile 160 of the user 102 consuming the audio recording, for example as further shown and described in FIG. 6.

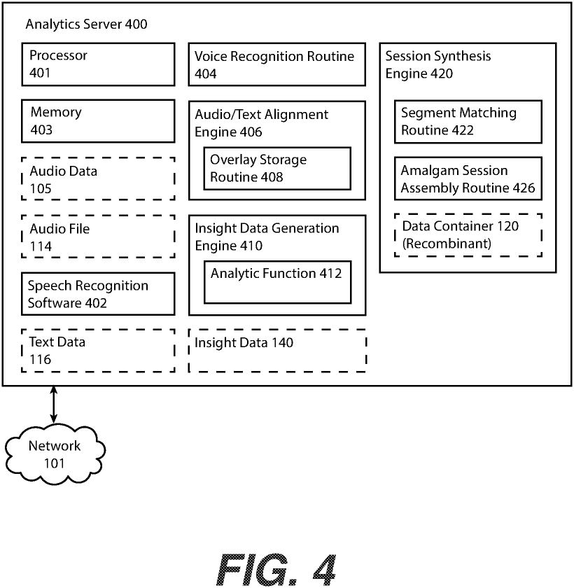

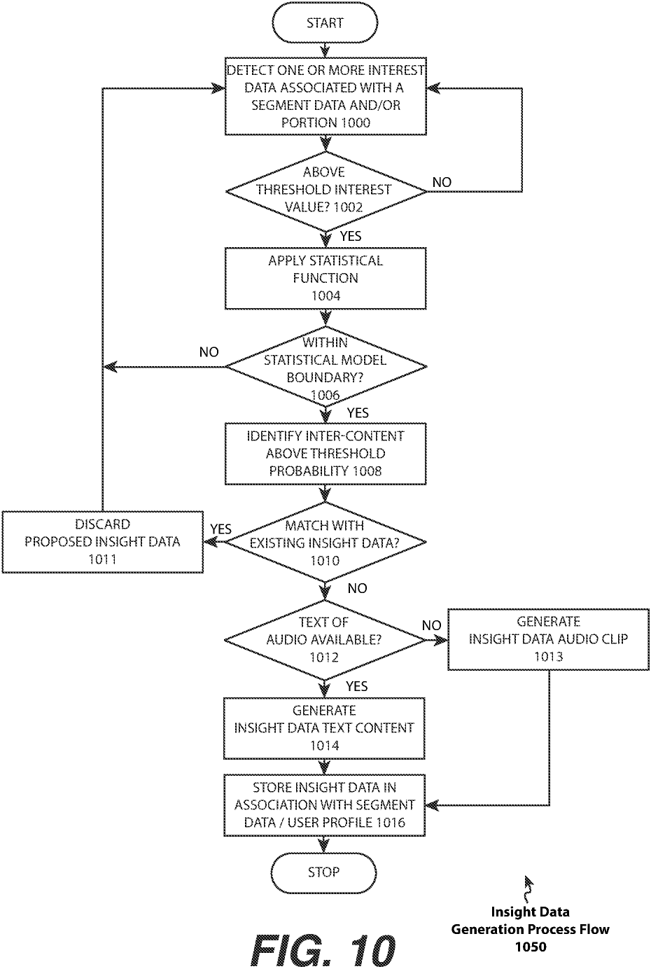

The segment data 110 may reference one or more instances of the insight data 140 derived from data stored within and/or otherwise associated with the segment data 140. Generation of the insight data 140 is further shown and described in FIG. 4, FIG. 10, and throughout the present embodiments. For example, in one or more embodiments the insight data 140 is determined based on two or more instances of the interest marker 108.

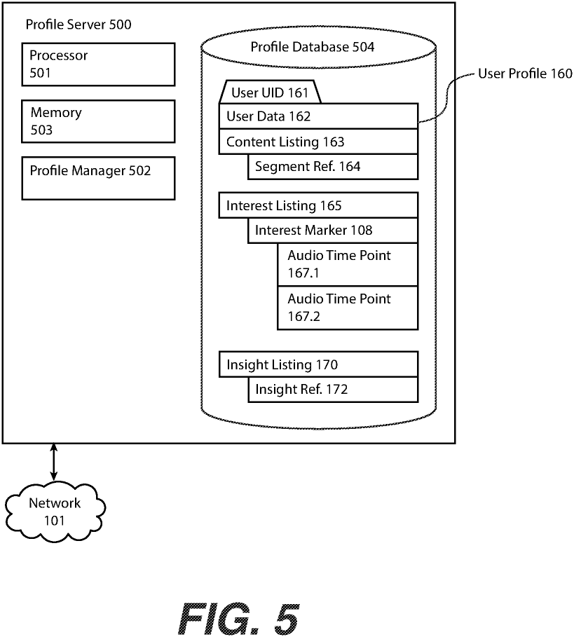

FIG. 1.4 illustrates a third data structure including attributes and/or values of the segment data 110, the data container 120, and the insight data 140, according to one or more embodiments. The segment data 110 is a data object that is stored in machine readable memory, and may include a segment unique identifier 111 by which the segment data may be uniquely identified and/or individually addressable within the database server 300. The segment data 110 may include an attribute for a database reference to a user profile 160 that owns and/or controls the segment data 110, shown as the user reference 112. The user reference 112 may store a value that is a user UID 161, as shown and described in FIG. 5. The segment data 110 may further include a container reference 113 that may be an attribute storing a value pointing to the data container 120 of the audio session for which the segment data 110 was originally created. The container reference 113 may store a value that is the container UID 121.

The segment data 110 may further include an audio data 105 that is recorded audio uploaded as a prerecorded file and/or received from one or more audio streams 104 (e.g., generated by one or more devices 600). However, in one or more embodiments, two or more audio data 105 may be maintained separately (e.g., an audio data 105A through an audio data 105N), and may be flattened and/or stored collectively with separate audio tracks as the audio file 114. Each audio data 105A through the audio data 105N may each include a user reference 115 that may designate a source (e.g., a user profile 160 associated with a device 600) for the audio data 105. Maintaining discrete audio tracks may assist in, for example, generation of separate text data 116 for each, may assist in determination of who is speaking following a speech recognition process (e.g., by the speech recognition software 402), and/or may assist in the accurate attribution of interest markers 108 and/or insight data 140 to an appropriate contributor (e.g., moderator, panelist, other participant). Each instance of the audio data 105 may be stored in a common digital audio format, for example: PCM, WAV, AIFF, MP3, AAC, OGG, WMA (lossless or lossy), FLAC, ALAC, and/or M4A.

The segment data 110 may include one or more instances of a text data 116 that may be a transcript of all of, or a portion of, one or more instances of the audio data 105. For example, the text data 116 may be a plaintext file that is a transcript of each instance of the audio data 105A through the audio data 105N. In one or more embodiments, the audio file 114 may be compressed into a single audio data 105 that may be utilized to generate the text data 116. Generation of the text data 116 is further shown and described in conjunction with the analytics server 400 in the embodiment of FIG. 4. Although a single instance of the text data 116 is shown in FIG. 1.4, in one or more embodiments each instance of the data 105A through the audio data 105N may include an associated instance of the text data 116 (e.g., a text data 116A through a text data 116N). The segment data 110 may further include a reference to one or more insight data 140 that may have been generated based on feedback, and/or interaction with respect to the segment data 110 from its creations and/or a consuming audience.

The data container 120 is a data object that may be stored in computer readable memory. The data container 120 may include a container UID 121 by which the data container 120 may be individually identified and/or uniquely addressed within a database such as the content database 310. The data container 120 may include one or more references to user profiles 160 that own and/or control the data container 120, specifically a user reference 122 attribute that may store as a value of a user UID 161.

The data container 120 may include a subject data 150, for example a free-form text data description of a subject. Alternatively, or in addition, the data container 120 may include references to one or more separate data objects representing subjects (e.g., as shown in the embodiment of FIG. 1.2, the subject references 124A through the subject reference 124N). The data container 120 may further include a content instruction data 125 which may store textual data that includes at a discussion topic, a debate motion, and/or a discussion prompt (e.g., a prompt for speaking, a question to be answered). Alternatively, or in addition, the data container 120 may include a reference to a data object representing a content instruction shown as the content instruction reference 126. In one or more embodiments, an audio distribution platform operating the structured audio data network 100 may generate and/or continually curate a database of subject data 150 and/or content instruction data 125 which may be optionally referenced when initiating an audio session and setting up the data container 120.

The data container 120 may include a session format data 130 that may specify a format for the audio session and each of its associated segments. The session format data 130 may include, for example, a panelist number 131 which may store a value of a number of panelists (e.g., users 102) that may participate in the audio session. A panelist criteria 132 may store a value of one or more data criteria for inclusion and/or selection of a panelist, moderator, and/or other contributor (e.g., a professional qualification, an educational degree, an area of expertise, a previous number of insight data 140 attributed to the user 102 on the platform, etc.). The panelist criteria 132 may be usable for example when assembling a random set of panelists and/or moderators for an audio session.

A segment format 133 specifies one or more segments 134, each of which will have an associated segment data 110. The segment 134 may include a time allocation 136 that may be a default time allocating the segment data 110. The user reference 137 may reference one or more user profiles 160 associated with users 102 who may generate audio streams 104 that will be stored as audio data 105 of the segment data 110.

In one or more embodiments, it should be noted that a segment 134 may also have no initial association with a user profile 160. This may be useful, for example, for dynamic allocation of a panelist and/or moderator to the segment 134 that is unassigned. The dynamic allocation can also accommodate the addition of what may initially be an user 102 who is initially a consumer of a live stream. For example, several instances of the segment 134 that are unassigned may be provided with 30 second time allocations for audience questions, where an audience member is dynamically assigned to the segment 134 after being “called on” by the moderator. In one or more embodiments, the audience member asking the question, and the panelist answering the question, may both become contributes to an audio data 105 in the discrete segment data 110.

The segment format 133 may be prescribed, customizable, and/or based on two or more selectable templates. For example, in one or more embodiment, a template may include one moderator and three panelists distributed amongst five segments. In segment 133A the moderator may introduce each panelist over two minutes (all participants may be recorded). In a segment 133B a first panelist may speak for three minutes. In segment 133C a second panelist may speak for three minutes. In a segment 133D a third panelists may speak for three minutes. And finally, in a segment 133E, the moderator and all panelists may collectively speak for four minutes. The result may be a short-form, structured podcast under 15 minutes.

Originally allocated time may be able to be yielded to the moderator and/or another panelist. Similarly, the moderator may be able to reduce and/or re-allocate time between and/among panelists. The result may be a dynamic format encouraging succinct content and encouraging participants to remain on topic, while also allowing for flexibility to meet the needs of the discussion and group dynamic.

In one or more other embodiments, the moderation and/or the recording of the audio session may occur asynchronously. For example, a first user 102A may set up and format the audio session and send invitations to a user 102B and a user 102C to participate as panelists. The user 102A may record an introduction which may be forwarded to the user 102B (e.g., on the device 600B). At a later time, e.g., the next day, a user 102B may the record audio and transmit audio to be stored in a segment data 110B. Finally, a week later, the user 102C may listen to both the introduction and the audio of user 104B, then record and transmit audio to be stored in a segment data 110C. The audio session may then be completed and ready for sharing and/or distribution platform. Such asynchronous audio sessions may promote the contribution of busy individuals, people from diverse cultures and time zones, and/or people with different priorities and schedules to further drive participation and generate new insight.

The data container 120 may further include a set of container insights 128 which may includes one or more insight references 129 to insight data 140. The insight reference 129 may include a reference to an insight data 140 generated in associated with a segment data 110 associated with the data container 120. For example, the insight reference 129 may enable a direct query of the data container 120 to determine all insight data 140 that have resulted from each of the associated segment data 110 of the data container 120.

The insight data 140 comprises high value data that is a subset of the audio file 114, the audio data 105, and/or the text data 116. The insight data 140 may be stored within the data container 120, within the segment data 110, and/or as a discrete data object comprising an insight UID 141 (as shown in the embodiment of FIG. 1.4). The insight data 140 may include an audio clip 145 and/or a text content 146. The text content 146 may be a word, a clause, a phrase, a sentence, one or more paragraphs, or any portion thereof, identified within the text data 116. The text content 146 may be specified by a character number or other location designator within the text data 116 and/or may include a portion of data copied from the text data 116. Similarly, the audio clip 145 may include a subset of the audio file 114 and/or the audio data 105, for example one second, three seconds, ten seconds, or one minute of the audio recording. The audio clip 145 may be designed by an audio time range beginning at a first audio time point and ending at a second audio time point, and/or may include a portion of data copied from the audio file 114 and/or the audio data 105. Identification and extraction of the text content 146 and/or the audio clip 145 are further shown and described throughout the present embodiments. The insight data 140 may further include segment reference 147 drawing a database reference to the segment data 110 giving rise to the insight data 140.

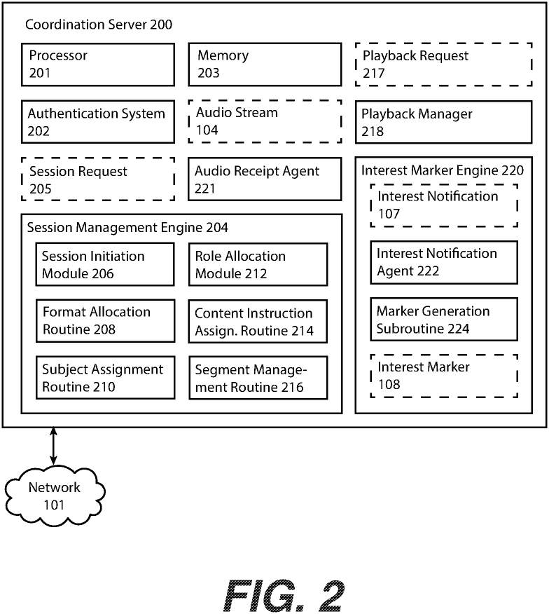

FIG. 2 illustrates a coordination server 200, according to one or more embodiments. The coordination server 200 comprises a processor 201 that is a computer processor and a memory 203 that is a computer readable memory (e.g., solid state memory, magnetic disk drive memory, random access memory (RAM), and/or a memristor, etc.). The coordination server 200 may include an authentication system 202 which may authenticate one or more users 102 and/or devices 600, for example when a user 102 and/or an associated instance of the device 200 attempts to access and/or utilize a user profile 102. The authentication system 202 may utilize multifactor authentication (e.g., a password, a biometric, and/or a physical device), out-of-band authentication, and/or other techniques known in the art of cybersecurity and identity management. Authentication may be useful to ensure content, audio recordings, interest markers 108, and/or insight data 140 are attributed to correct instance of the user profile 160.

In one or more embodiments, the coordination server 200 may include a session management engine 204, a session initiation module 206, a format allocation routine 208, a subject assignment routine 210, a role allocation module 212, a content instruction assignment routine 214, and/or a segment management routine 216. The session management engine 204 may be a software application and/or portion of a software application that manages an audio session for generating audio recordings for one or more user 102 that may be moderators and/or panelists, including for example remote sessions conducted over the network 101. The session initiation module 206 may be a software application and/or portion of a software application that configures and then initiates a new audio session at the request of one or more users 102, including possibly initiating setup of a data container 120 for the prospective audio session. In one or more embodiments, the session management engine 204 may include computer readable instructions that when executed dynamically reallocate the session format data 130 through changing the panelist number 131, adjusting the panelist criteria 132, adjusting the segment composition (e.g., adding or removing one or more segments 134), and/or adjusting the time allocation 136 of one or more of the plurality of segments 134.

In one or more embodiments, the session initiation module 206 includes computer readable instructions that when executed receive a session request 205 for creation of an audio session from a device 600 of a user 102. The session request 205 may include a user UID 161 of the user 102 and a content instruction data 125 for generating an audio recording for the audio session. The name or title of the audio session (e.g., the title data 127), and formatting and/or structure of the audio session may be transmitted along with the session request 205. Alternatively, the title data 127 and any formatting may be selected or edited following initial setup of the audio session.

The format allocation routine 208 may be a software application or portion of a software application that sets up, configures, and/or structures the audio session, including initiating appropriate updates to the data container 120 (e.g., writing the session format data 130, as shown and described in conjunction with the embodiment of FIG. 1.4). In one or more embodiments, the format allocation routine 208 may include computer readable instructions that when executed specify a session format data 130. The session format data 130 may include a panelist number 131, a panelist criteria 132, and a segment composition comprising a plurality of segments 134 each of which may have a time allocation 136 and/or other constraints. Instructions that may be received and processed by the format allocation routine 210 may originate on a software application on the device 600 of the user 102 initiating the audio session, for example set up through menus on the UI of the software application. The format allocation routine 210 may also receive a selection of a format template, retrieve data related to the format template, and utilize the format template to define the data in the session format data 130 of the data container 102.

The subject assignment routine 210 may be a software application or portion of a software application that assigns a subject to the data container 120 and/or segment data 110. The subject may be freeform text received from the device 600 and/or may be a referenced data object representing a subject selected from a list (e.g., selected from a menu of the software application running on the device 600). The subject may also be determined through analysis of one or more audio data 105 and/or text data 116 stored in segment data 110 associated with the data container 120. In one or more embodiment, the subject assignment routine 208 includes computer readable instructions that when executed receive a subject designation from one or more users 102, and associates a subject data 150 with the data container 102. The association of the subject data 150, for example, may be direct storage of the subject data 150, and/or a reference to the subject data 150 (e.g., via the subject reference 124 of FIG. 1.4). The subject designation may be the selection of the subject by the user 102, for example as may be generated on the device 600 of the use 102 through a graphical user interface.

The role allocation module 212 may be a software application and/or a portion of a software application that assigns and/or sets up roles of users 102 within the audio session, and/or invites participation by users 102 in the audio session. For example, a user 102 setting up the audio session may enter the names, unique identifiers, and/or panelist criteria 132. Invitations may be sent through a software platform to a native application running on the device 600, to an email address of a user 102, and/or through other methods known in the art. In one or more embodiments, the role allocation module 212 includes computer readable instructions that when executed designate a panelist role for a user profile 160 of a user 102 to define two or more panelist users and/or designate a moderator role for a user profile 160 of the user 102 and/or a different user 102 to define a moderator user. In one or more embodiments, the role allocation module 212 comprises computer readable instructions that when executed assign each of the two or more panelist users to at least one of the plurality of segments 134 (e.g., a first user 102A assigned to a first segment 134A represented by a first segment data 110B, a second user 102B and a third user 102C both assigned to a second segment 134B represented by a second segment data 110B, etc.).

The content instruction assignment routine 214 may be a software application and/or a portion of a software application that assigns, sets, and/or defines a content instruction data 125. The content instruction data 125 may include data describing human-readable discussion topics, prompts to be spoken to of addressed, a motion to be debated, a question to be answered, and/or other boundaries of discussion. The content instruction data 125 may include freeform text received from the device 600 and/or may include a data object representing a content instruction selected from a list (e.g., selected from a menu of the software application running on the device 600). For example, the content instruction data 125 may include plaintext specifying: “Does the Allan Hills 84001 meteorite prove life existed on Mars?”, “Fastest holiday recipes”, or “Describe your most ambitious career goal”. The content instruction data 125 may also be determined through analysis of one or more audio data 105 and/or text data 116 stored in segment data 110 associated with the data container 120.

The segment management routine 216 may be a software application and/or a portion of a software application that initiates, manages, and/or defines each segment data 110 that may be generated, for example in association with an audio session. In one or more embodiments, the segment management routine 216 may include computer readable instructions that when executed stores a set of audio data 105 (e.g., an audio data 105A, and audio data 105B) within a set of segment data (e.g., a segment data 110A, a segment data 110B), where each segment data 110 may be assigned a segment UID 111 and each segment data 110 may be associated with the first data container 110 through a reference attribute (e.g., the container reference 113 and/or the segment reference 135). The set of audio data 105 may include a first audio data 105. In one or more embodiments, the segment management routine 216 may include computer readable instructions that when executed receive a segment attenuation instruction for a first audio stream 104 of a set of audio streams 104, the segment attenuation instruction generated by the moderator user (e.g., the user 102 having the moderator role) or a panelist user of the two or more panelist users (e.g., a user 102 having a panelist role). In one or more embodiments, the segment management routine 216 may include computer readable instructions that when executed initiate storage of a second audio data 105 generated from the set of audio streams 104 in a second segment data 110. The segment management routine 216 may includes software instructions that when executed write, edit, and/or otherwise define the data stored in the segment data 110, for example the user reference 112, visuals or video associated with the segment data 110, etc. The segment management routine 216 may also receive and store audio recordings received from the audio receipt agent 221, including routing to an appropriate segment data 110 for storage.

An audio receipt agent 221 may be a computer application and/or a portion of a computer application that receives and processes audio streams 104 and/or prerecorded instances of the audio data 105 from one or more devices 600 participating in an audio session. The audio streams 104 may be converted to an audio data 105, and/or the audio data 105 may be changed in format, combined, and/or otherwise modified before forwarding to the session management engine 204 and/or the database server 300. In one or more embodiments, the audio receipt agent 221 includes computer readable instructions that when executed receive an audio data 105 from a device 600 of a user 102 over a network 101. Similarly, the audio receipt agent 221 may include computer readable instructions that when executed receive a set of audio streams 104 from the two or more panelist users for each of the plurality of segments 134.

The coordination server 200 may also process incoming playback requests 217 and coordinate the streaming and/or delivery of audio data 105. The playback request 217 may include a unique identifier associated with one or more audio records. For example, the playback request 217 may include a container UID 121 (which may initiate playback of all segments associated with the data container 120 in order, e.g., as each may be sequentially referenced by each segment reference 135) or a segment UID111. In one or more embodiments, a playback manager 218 includes computer readable instructions that when executed receive a playback request 217, for example received from a device 600 of a user 102. The playback request 217 may include the container UID 121 of the data container 120. The playback manager 218 may include computer readable instructions that when executed stream an audio data 105 of a segment data 110 to the device 600 of the user 102.

In one or more embodiments, the coordination server 200 may include an interest marker engine 220 that may be a software application and/or portion of a software application that receives and processes interest notifications 107 and generates interest markers 108. Each interest marker 108 may include data specifying a portion of the audio data 105 and/or the text data 116 associated with a segment data 110. The interest marker engine 220 may include an interest notification agent 222 and a marker generation subroutine 224. In one or more embodiments, the interest notification agent 222 may receive an interest notification 107 from the device 600 of a user 102. The interest notification 107 may include a segment UID 111 of a segment data 110, a first audio time point and a second audio time point (e.g., data specifying 3 minuets, 42 seconds and 3 minutes, 57 seconds, respectively). Alternatively, or in addition, the interest notification 107 may include an audio time point (e.g., a single audio time point, such as fourteen minutes, fifty seconds, and two hundred milliseconds) and/or an audio time range (seven seconds beginning at 5:60).

The marker generation subroutine 224 may include computer readable instructions that when executed generate an interest marker 108 that includes the segment UID 111 of the segment data 110 (e.g., the segment 110 identified in the interest notification 107), and the data utilized to specify the location of interest with the audio data 105, for example an audio time point, a pair of values that is the first audio time point and the second audio time point, and/or the audio time range. The marker generation subroutine 224 may also include computer readable instructions that when executed store the interest marker 108 in association with the user UID 161 of the user 102, and optionally may store the container UID 121 of the data container 102, the segment UID 111 of the segment data 110, and/or the user UID 161 of a different user 102 that generated (and/or contributed to) the audio data 105.

In one or more embodiments, the exact or likely portion of the audio data 105 referenced by the interest notification 107 may be determined following receipt of the interest notification 107 but prior to generation of the interest marker 108. In one or more embodiments, an audio time point and/or an audio time range may be compared against the audio data 105 and/or the text data 1116 to determine what may be a likely and/or natural discrete section of audio and/or text data. For example, in one or more embodiments, a call may be made to the audio / text alignment engine 406 of the analytics server 400. In one or more embodiments, the audio / text alignment engine 406 may determine a text content 146 that is a word, a clause (e.g., text between punctuation or conjunctions), a clause, a phrase, a sentence, a paragraph, and/or another discrete set of text within the text data 116 and that corresponds to the audio time point and/or fits the audio time range. For example, where the audio time point specifies a single point in time (e.g., 1 minute, 34 seconds), the time / text alignment engine 406 may reference the text data 116 at a location corresponding to 1 minute, 34 seconds of the audio data 105 (e.g., character number four hundred and thirty-two), and then expand to a predetermined limit on either side (e.g., to the start of the sentence that includes character number 432). A range may therefore be generated in either audio times and/or text locations, and utilized in generation of the interest marker 108 specifying the content.

As further shown and described in conjunction with the embodiment of FIG. 6, the interest data 108 may be stored in association with the user profile 160. In other words, in one or more embodiments, the interest data 108 may be personal to a user 102 and therefore primarily may be associated with their user profile 160. The user 102 may be able to review, edit, manage, rank, rate, categorize and/or share their interest markers 108 (e.g., send a soundbite or text excerpt to a friend from a smartphone, including a link or other instructions for obtaining the full audio recording). Such management of the interest markers 108 of the user 102 may be able to be effected through a user interface of a software application running on the device 600, optionally accessing data stored and/or backed up to the profile server 600. Examples of what may be selected as interest markers 108, could include: useful information stated by an expert panelist (e.g. “water above two thousand parts per million total dissolved solids can be difficult or impossible to treat”), a controversial assertion (e.g., “the primary reason the Soviet Union collapsed was structural institutional failure that began in the Brezhnev era”), a prediction (e.g., “the Federal Reserve will have to cut rates by June . . .”), or content for follow up (e.g., “an excellent adventure children’s book for age 5 through 8 is Twenty-One Balloons” by William Pène du Bois).

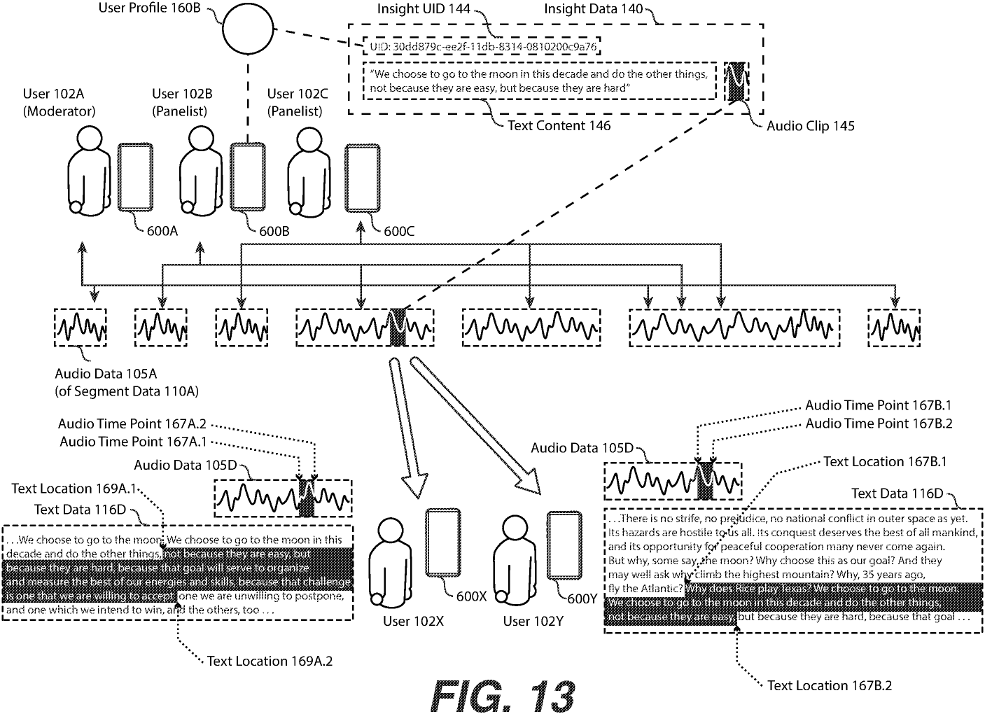

It should be noted that, as described below, the text content 146 may be a portion of the text data 116 as specified by and/or as may be copied into a distinct data object. Both the interest data 108 and/or the insight data 140 may include the text content 146, each of which may carry different significance depending on use, as for example shown and described in conjunction with the embodiment of FIG. 13.

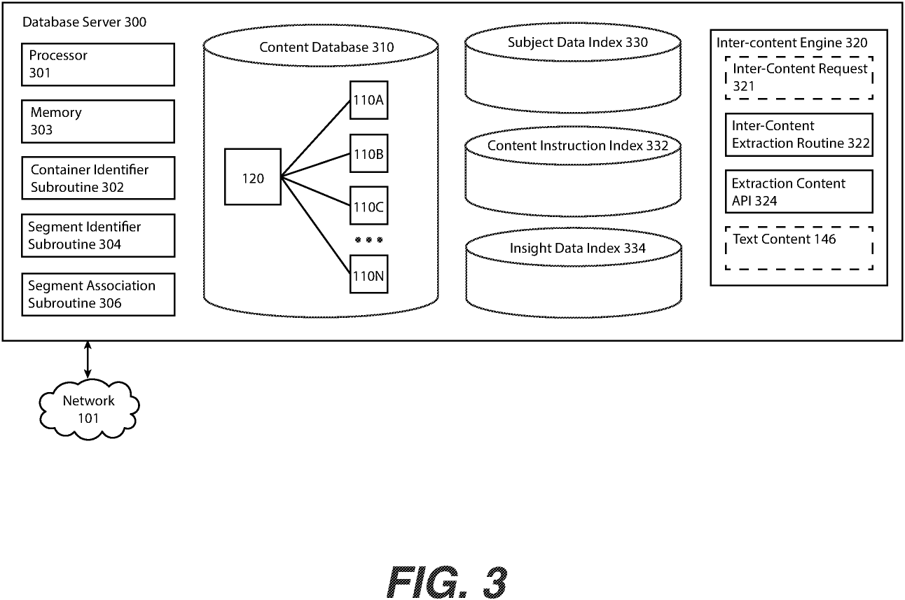

FIG. 3 illustrates a database server, according to one or more embodiments. The database server 300 may include a processor 301 that is a computer processor and a memory 303 that is a computer readable memory. The database server 300 may include a content database 310 and various routines and subroutines for reading, writing, updated, and/or deleting the data structures and associated data illustrated in the embodiments of FIG. 1.2 through FIG. 1.4. A container identifier subroutine 302 may include a software application or portion of a software application that generated and appends a unique identifier to a data container 120, e.g., the container UID 121. In one or more embodiments, the container identifier subroutine 302 includes computer readable instructions that when executed generate and/or assign a container UID 121 to the data container 102.

The segment identifier subroutine 302 may include a software application or portion of a software application that generates and appends a unique identifier to a segment data 110, e.g., the segment UID 111. The segment association subroutine 306 may include a software application or portion of a software application that associates each segment data 110 of a segment 134 originally defined in an audio session with that data container 120 storing data of that audio session, for example as shown and described in conjunction with the embodiment of FIG. 1.4. the container UID 121 and/or the segment UID 111 may each be generated as globally unique identifier (GUID) as known in the art of computing science.

In one or more embodiments, it may be an objective to independently identify each segment data 110. In one or more embodiments, independent existence and/or addressability of the segment data 110, apart from its modeling as a subsection of an audio session, may enhance the ability for attribution of interest markers 108 and/or interest data 140, as further shown and described herein. In addition, such independent existence and/or addressability may enable recombinant instances of the data container 102, also as shown and described herein.

The segment association subroutine 306 may include computer readable instructions that when executed associate a segment data 110 with the data container 120 through a reference attribute. For example, the segment association subroutine 306 may store the segment UID 111 as a value of the segment reference 135 attribute, as shown in FIG. 1.4, and/or may store the container UID 121 as a value in the container reference 113 attribute.

The database server 300 may include one or more indexes of data stored in the data structures of FIG. 1.2 through FIG. 1.3, including for the enhancement of query efficiency and content recombination. A subject data index 330 include an index of subject data 150, including for distinct data objects and/or subject data 150 stored within a data container 120 and/or segment data 110. For example, the subject data index 330 may include a word index of words used in plaintext free-form subject descriptions along with the container UID 121 of the data container 120 in which the word is stored. The subject data index 330 may enhance the capability of a user 102 to search for audio and/or text related to a certain subject (e.g., through an interface of a software application on the device 600). Similarly, a content instruction index 332 may store an index for the content instruction data 125 of each data container 120, whether stored in the data container 120 or as a separate data object that may be uniquely identified and referenced through the content instruction reference 126. The subject data index 330 may enhance the capability of a user 102 to search for audio and/or text related to a certain content instruction.

The insight data index 334 may store an index of one or more instances of insight data 140. The insight data index 334 may enable searching based on high value content and/or insightful content. This may be useful where, for example, a user 102 wishes to find a highly insightful passage and/or excerpt regarding certain content. The insight data index 334 may increase the likelihood that the user 102 will find content that includes key information relative to what may be existing methods using standard natural language and/or terms and connectors search that may scan over or query an index derived from the entire set of content. Although not shown in the embodiment of FIG. 1.4, it should be noted that the insight data 140 may also be “tagged” with additional metadata, for example designating a quote as “fact”, “analysis”, or “opinion”, or for example a tag such as “funny”, “inspirational,” or even an emoji. Such tags may be included in the insight data index 334. Tags may be manually or automatically appended. For example, in one or more embodiments, a set of interest notifications 107 may have included tags set by each user 102 originating the interest notifications 107, where the most popular tags may be extracted and appended to the insight data 140.

The database server 300 may include an inter-content engine 320, according to one or more embodiments. The inter-content engine 320 may include a software application or portion of a software application that may extract content from audio recordings and/or transcripts and make them accessible through an application programming interface (API) and/or otherwise communicate the extracted content to external servers or third-party systems. In one or more embodiments, an inter-content request 312 may be received by the inter-content engine 320. The inter-content request 312 for example, may request an insight data 140, an interest data 108, a segment data 110, a text data 116, data describing the data container 120, data describing the segment data 110, and/or other data. For example, an inter-content request 312 may be generated from a social media server (e.g., Facebook®, Instagram®, LinkedIn®, etc.) to retrieve an insight data 140 generated by a user 102 having a social media account, where the text content 146 of the insight data 140 may be automatically displayed on the home page of the social media profile of the user 102.

In one or more embodiments, the inter-content extraction routine 322 may include computer readable instructions that when executed extract a text content 146 of an interest marker 108, for example to be made available through API. The text content 146 of the interest marker 108 may be made accessible at the request of either the user 102 generating the interest notification 107 resulting in the interest marker 108 and/or to the user 102 associated with generating the audio data 105 (e.g., a panelist whose voice speaks on the audio recording). It is also possible for interest data 108 generated by a consuming audience to be accessible by a panelist user 102 who generated the audio data 105.

In one or more embodiments, the inter-content extraction routine 322 includes computer readable instructions that when executed extract the text content 146 of the insight data 140 (and/or the interest marker 108). In one or more embodiments, the inter-content extraction routine 322 includes computer readable instructions that when executed authorize access through an API (e.g., the extraction content API 324) to a text content 146 of an insight data 140 (and/or an interest marker 108) by an API key controlled by a user 102. The user 102 controlling the API key may be, for example, the user 102 acting as a panelist in the segment data 104 from which the insight data 140 and/or interest marker 108 derive.

In one or more embodiments, the inter-content extraction routine 322 includes computer readable instructions that when executed respond to a remote procedure call from a social media network by transmitting the text content 146. For example, a computing process running on a social media server may periodically generate a call to the database server 300 over the network 101 to retrieve any new insight data 140 that has resulted from consumption of a user 102′s content.

Similarly, in one or more embodiments, inter-content extraction routine 322 includes computer readable instructions that when executed dynamically updates the insight data 140 upon generation of, and analysis of, additional interest markers 108. For example, it may be determined above the threshold probability that that a set of interest markers 108 are directed to a different instance of the text content 146. This “honing in” on the appropriate insight data 140 may occur as additional interest notifications 107 are generated, and is further shown and described in conjunction with the embodiment of FIG. 13.

FIG. 4 illustrates an analytics server 400, according to one or more embodiments. The analytics server may include a processor 401 that is a computer processor and a memory 403 that is a computer readable memory. In one or more embodiments, the analytics server 400 may carry out a number of additional processing and/or analytical operations on data of the segment data 110, the data container 120, the audio data 105, the audio file 114, the text data 116, and/or other data. The analytics server 400 may include and/or make a call to a speech recognition software 402 that may be a software application or portion of a software application for recognizing speech within an audio recording and/or converting an audio recording into text. For example, the speech recognition software 402 may include a call to Google Speech API, IBM Watson API, SpeechAPI, Siri API, and/or Wit API. A speech recognition subroutine 405 may receive a call for speech recognition (e.g., of an audio data 105) and in turn may call the speech recognition software 402. In one or more embodiments, the speech recognition subroutine 405 may include computer readable instructions that when executed apply the speech recognition software to a segment data 110 (e.g., to the audio file 114 of the segment data 110 and/or to one or more audio data 105 of the segment data 110) to generate one or more instances of the text data 116.

In one or more embodiments, the text data 116 may be a transcript of an audio recording such as the audio data 105. Where audio data 105 from one or more users 102 are stored in the same segment data 110 (and/or compiled into the same audio file 114), the text data 116 may specify which user 102 is speaking. In one or more embodiments, each audio stream 104 from each user 102 (e.g., an audio stream 104A from the user 102A, an audio stream 104B from a user 104B) may be stored discretely as instances of the audio data 105 (e.g., an audio data 105A and audio data 105B). Speech recognition of each audio data 105 may then occur individually, with the resulting transcript (e.g., the text data 116) compiled based on the points of time within each audio data 105 corresponding to each portion of recognized speech. For example, a moderator user may begin to introduce a panelist user at the beginning of a segment in which both users 102 are contributing to an audio recording. At a time in the audio data 105A equal to zero minutes and one second, the moderator user may be recorded as saying: “I would like to introduce you to doctor Patel of the Institute of Regenerative Medicine . . .”). At a time in the audio data 105B equal to zero minutes and eighteen seconds, the panelist user may be recorded saying: “thank you doctor Strictland, it is my pleasure to be your guest . . .”) The resulting text file 116 may include markup, for example:
[00:01:00] <User UID of Dr. Strictland> “I would like to introduce you to doctor Patel of the Institute of Regenerative Medicine . . .”
[00:18:00] <User UID of Dr. Patel> “thank you doctor Strictland, it is my pleasure to be your guest...”

Alternatively, or in addition, the analytics server 400 may include a voice recognition routine 404 that includes a software application or portion of the software application that may be utilized to parse and/or recognize one or more voices on an audio file 114 and/or an audio data 105. The voice recognition routine 404 may be available through the speech recognition software 102, and unique voice recognition data and/or profiles may be stored in association with the user profile 160 of each user 102.

The analytics server 400 may include an audio/text alignment engine 406 that includes a software application or portion of a software application that may associate a time of an audio recording (e.g., the audio file 114, the audio data 105) with a location within textual data (e.g., the text data 116). In one or more embodiments, the audio/text alignment engine 406 includes computer readable instructions that when executed associate the text data 116 with the audio data 105 (e.g., the text data 116 generated as an output of the speech recognition software 402) to determine for the segment data 110 a playback time (e.g., of the audio data 105) at a text location within the text data 116. In one or more embodiments, the audio/text alignment engine 406 includes computer readable instructions that when executed maps an audio time point 167 of an audio data 105 to a text location 169 of the text data 116. A time overlay may be a map at two or more audio time points 167 (e.g., every one second of the segment 134) to two or more points in the text data 116, or, conversely, a map of two or more text locations 169 in the text data 116 (e.g., each word) to two or more audio time points 167. The text location may be approximate, and/or may be centered on a word, sound, or clause. One example of a text location may be a character location which specifies a character number within the text file. An example of a text location (e.g., the text location 169) is illustrated in FIG. 13. The overlay storage routine 408 may include a computer application or portion of a computer application that overlays and/or aligns a textual transcript with an audio recording. For example, each of the audio times and associated text locations may be stored and/or mapped by the overlay storage routine 408. In one or more embodiments, the overlay storage routine 408 includes computer readable instructions that when executed store a time overlay of the text data 116 in association with a segment data 110 such that at least two characters of the text data 116 are associated with at least two audio time points of the segment data 110.

The analytics server 400 may include an insight data generation engine 410 that may be a software application or portion of a software application that evaluates data from the data container 120, the segment data 110, and/or interactions with either (e.g., generation of the interest notification 107, analysis of interest data 108, consuming users 102 pausing and rewinding to re-listen to a portion, etc.). In one or more embodiments, the insight generation engine 410 may utilize one or more interest markers 108 to determine content that is likely high-value to a general or specialized audience. For example, where a threshold number of interest markers 108 select the same or similar content, it may be determined that a portion of the audio data 105 and/or text data 116 may contain high value and/or insightful content. The threshold may be, for example, that 3% of all users 102 who consume an audio data 105 generate an interest notification 107 associated with the portion. In another example, the threshold may occur where 20% of all users 102 who generate any interest notification 107 for the audio data 105 generate an interest data associated with that portion.

In one or more embodiments, the insight data generation engine 410 may determine a text content 146 that is a portion of a text data 116, and/or may determine an audio clip 145 that is a portion of the audio data 105. An analytic function 412 may be utilized to determine a probability that one or more interest markers 108 are intended to point to the same portion (e.g., a dataset comprised of a single time points, one placed by each user 102 generating an interest notification 107 within a statistically significant distance of one another). In what may optionally be a at least a two-part process, an analysis may be conducted to determine groupings of the designated portions likely to be associated with a common or related insight. Each grouping may then be further analyzed to more particularly determine the appropriate portion with which to designate in the insight data 140.

In one or more embodiments, a machine learning algorithm may also be employed to group and/or correlate interest data 108 as directed toward the same locus of high value content, and/or further to identify the most likely high-value content. For example, the analytic function 412 may include a machine learning algorithm for clustering of data based on K-Means, Mean-Shift Clustering, Density-Based Spatial Clustering of Applications with Noise (DBSCAN), Expectation-Maximization (EM) Clustering using Gaussian Mixture Models (GMM), Agglomerative Hierarchical Clustering, and/or other techniques known in the art.

In one or more embodiments, the insight data generation engine 410 includes computer readable instructions that when executed determine above a threshold probability that a first interest marker 108A and a second interest marker 108B are both directed to a text content 146C that is at least partially outside of a text content 146A specified by the interest marker 108A and/or the text content 146B specified by the interest marker 108B. The insight data generation engine 410 may include computer readable instructions that when executed generate an insight data 140 to specify the text content 146C. The insight data 140 may include the text content 146C, data specifying a text location of the text content 146C within a text data 116, a portion of an audio data 105, and data specifying an audio location of an audio clip 145 within the audio data 105 of the segment data 110. The insight data generation engine 410 may include computer readable instructions that when executed store the insight data 140 in association the container UID 121 of the data container 120 and/or the segment UID 111 of the segment data 110.

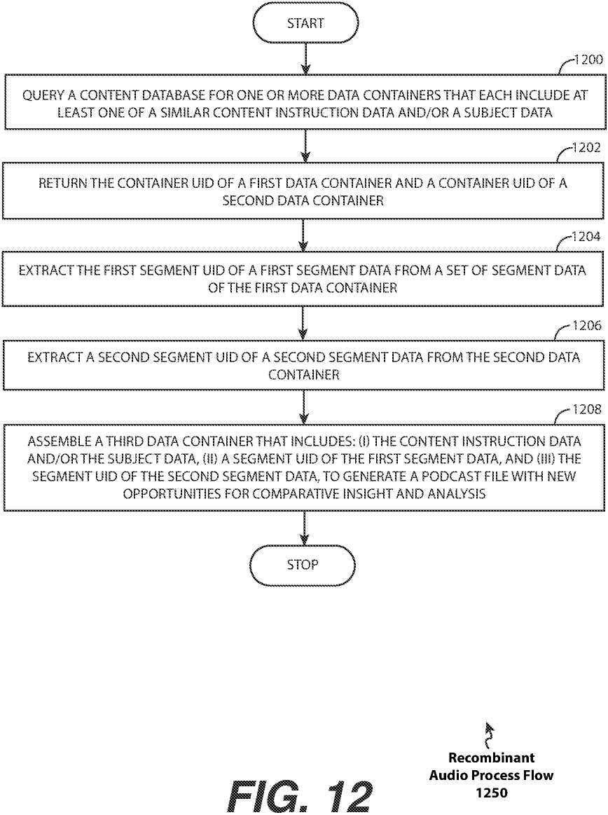

The analytics server 400 may include a session synthesis engine 420 that may include a software application or portion of a software application that may determine audio records and/or transcripts that are combinable into new content, including for example as may be used to create high value, curated, novel, compared, contrasted, similar, different, and/or varied content. Various data may be utilized to determine audio recordings that can be utilized to generate an effective recombinant instance of the data container 120, for example as shown and described in conjunction with the embodiment of FIG. 1.2 and FIG. 12.

In one or more embodiments, the session synthesis engine 420 may include computer readable instructions that when executed query the session database 310 for one or more data containers 102 for a common data characteristic, for example a content instruction data 125 and/or a subject data 150. A container dataset may be temporarily stored, for example comprising an array of container UIDs 121. A segment matching routine 422 may include a computer application or portion of a computer application that determines two or more data containers 120 with segments to be recombined. For example, the common data characteristic may be a subject data 150 that includes “Heroism”, further narrowed by the term “saved” or “save” in the content instruction data 125. The resulting container dataset may generally include recordings from audio sessions related to heroism and personal accounts of heroic deeds. A selection may then be made for several segment data 110 associated with at least one of the data containers 120 within the dataset based on additional criteria. For example, it may be an objective to have one segment of a heroic story from a panelist user in each of ten age demographics (e.g., 0-9 (e.g., a story of a child saving a puppy), 10-19, 20-29 ... 90-99 (e.g., a heroic war story of a Korean War veteran)). Other criteria may be the most demonstrably interesting and/or insightful content, for example segments giving rise to and/or having the most associated interest markers 108 and/or interest data 140.

In one or more embodiments, the session synthesis engine 420 includes computer readable instructions that when executed return a container UID 211A of a first data container 210 and a container UID 211B of a second data container 210, extract a first segment UID 111A of a first segment data 110A from the first data container 120A, and then extract a second segment UID 111B of a second segment data 110B from the second data container 120B. The segment data 110A and the segment data 110B may then be utilized in the creation of a new, recombinant instance of a data container 120. An amalgam session assembly routine 426 may include a computer application or portion of a computer application that builds a new data container 102, including for example creating a new data object, assigning a new instance of the container UID 121, automatically storing the subject listing 123 and/or the content instruction 125 that may have been used to originally compile the container dataset, and storing new instances of the segment reference 135.

In one or more embodiments, the amalgam session assembly routine 426 includes computer readable instructions that when executed assemble a data container 120 (e.g., a recombinant instance of the data container 120), where the data container 120 that is assembled includes (i) the content instruction 125 and/or the subject data 123, (ii) the first segment UID 111 of first segment data 110 (e.g., stored as a value of a first segment reference 135 attribute), and (iii) the segment UID of the second segment data (e.g., stored as a value of a second segment reference 135 attribute). In one or more embodiments, the result may include a podcast file with new opportunities for comparative insight and analysis.

FIG. 5 illustrates a profile server 500, according to one or more embodiments. The profile server 500 may include a processor 501 that is a computer processor and a memory 503 that is a computer readable memory. The profile server 500 may include and/or remotely access a profile database 504 storing one or more user profiles 160. A profile manager 502 may be a software application or portion of a software application that may setup, write, edit, update, and delete instances of the user profile 160 and the data therein. For example, the profile manager 502 may respond to a request to set up new user profiles 160 for a new user 102 joining an audio recording and/or distribution platform operated by a company. The profile manager 502 may continue to update the user profile 160 following initial setup, for example associating the interest data 108 generated by the associated user 102 when the user 102 acts as a consumer of audio records, and/or associating insight data 140 attributed to the user 102 when the user 102 acts as a contributor to audio recordings (e.g., a moderator, a panelist).

The user profile 160 may include a user UID 161 which may uniquely identify the user profile 160 (e.g., a globally unique identifier). The user profile 160 may include user data 162, including for example a real name of the user 102, contact information, location information, device information (e.g., technical and/or identity information for the device 600 of the user 102), demographic information (age, gender, birth date, etc.), interests of the user 102 (including for example favorite instances of the subject data 150), account information (e.g., billing information), and other data.

In one or more embodiments, the user profile 160 may include several listings storing and/or referencing data objects, including a content listing 163, an interest listing 165, and/or an insight listing 170. The content listing 163 may include the segment references 164, each storing a value of a segment data 110 to which the user 102 contributed to the audio data 105. Although not shown, references may also be stored for any data container 120 to which the user 102 contributed. The role of the user 102 may also be stored (e.g., sponsor, moderator, panelist, and/or other roles). The interest listing 165 may store each of the interest markers 108 resulting from interest notifications 107 generated by the user 102. For example, one instance of the interest marker 108 is shown, including an audio time point 167.1 and an audio time point 167.2. Alternatively, or in addition, references may be made to the interest data 108 that may be stored in a separate location or database. The insight listing 170 may store and/or reference (e.g., through an insight reference 172) one or more insight data 140 attributable to the user 102. A variety of factors may be used to determine attribution. In one or more embodiments, the attribution may be determined where a voice of the user 102 is determined to have be included within the audio clip 145 and/or in association with the text content 146 of the insight data 140. This may be automatically determined where an audio stream 104 from the device 600 of the user 102 only stores the voice of the user 102. In other cases, an insight data 140 may be attributable to the user 102 where the user 102 merely participates in the same audio session. It should be noted that, in one or more embodiments, it is possible for more than one user 102 to be attributed to an insight data 140.

FIG. 6 illustrates the device 600 of FIG. 1, for example usable by the user 102 to setup and/or participate in audio sessions, record and/or stream audio, to consume audio recordings, and/or dynamically adjust format of an audio session, and/or to generate interest notifications 107, according to one or more embodiments. The device 600 may be, for example, a desktop computer, a server computer, a laptop computer, a tablet device, or a smartphone. The device 600 may include a processor 601 that is a computer processor and a memory 603 that is a computer readable memory. The device 600 may include a display 605 that may be integrated and/or connected (e.g., an LCD screen). The device 600 may also include and/or may be connected to a microphone 607 usable to record audio recordings and a speaker 609 usable to listen to audio recordings. In one or more embodiments, a camera 611 may also be utilized to provide a video feed. For example, each panelist user and/or moderator user may provide a short video introduction of themselves prior to recording primarily audio. Alternatively, in one or more embodiments a video feed may be concurrently recorded along with the audio feed and included as part of the segment data 110. In such cases, the segment data 110 of FIG. 1.4 may include one or more instances of video data from each user 102.

A playback application 602 may receive one or more instances of the audio file 114 and/or an audio data 105 and play such audio recordings on the speaker 609. In one or more embodiments, it should be noted that all audio recordings associated with each data container 120 (e.g., each audio data 105 associated with each segment data 110 associated with a data container 120) may be compiled and/or compressed into a single file and/or dataset before download by and/or streaming to the device 600. The playback application 602 may be part of a software application running on the device 600 (e.g., a mobile app), and may also utilize native operating system functions to decode, decompress, and/or play the audio recording.

A content selection routine 604 may include a computer application or portion of a computer application that allows the user 102 to select a portion of the audio recording, e.g., through a visual representation of the audio recording on the display 605. For example, in one or more embodiments, while the user 102 is listing to an audio recording, a timeline of the audio recording, the waveform of the sound of the audio recording, and/or the transcript of the audio recording may also be displayed on the display 605. The user 102 may then be able to interact with the graphical user interface to “drop” a point of interest, or “bookend” a start and stop time of a point of interest (e.g., highlight the waveform, timeline, and/or transcript). The interest notification generation routine 606 includes a software application or portion of a software application that receives an instruction to generate an interest notification 107, including receiving a selection from the content selection routine 104. The interest notification 107 may then be transmitted over the network 101 to one or more servers (e.g., the coordination server 200, the analytics server 400, the profile server 500).

An audio stream generation routine 608 may be a software application or portion of a software application that records and/or streams audio recordings generated with the device 600. In one or more embodiments, the audio stream generation routine 608 may receive an instruction from the user 102 to record audio and/or receive an instruction to begin recording audio in association with an ongoing audio session (e.g., when it is the user 102′s turn to contribute). The session/segment control routine(s) 610 may include a computer application or portion of a computer application that displays, manages, and/or communicates with the user 102 during an audio session. For example, a graphical user interface projected on the display 605 may show the user 102 who is currently speaking as part of an audio session, how soon before a designated segment will occur in which the user 102 is designated and/or scheduled to speak, and/or allow certain interaction with the audio session. Such interactions, for example, may include yielding time, “raising a hand” to speak, requesting additional time from a moderator user, “passing” a segment so as not to contribute, and also what may be more common controls such as mute, squelch, and toggle video on or off. In one or more embodiments, the session/segment control routine 610 may generate an attenuation instruction 612 for ending a segment of the user 102 (and/or the user 102′s participation in a segment of two or more users 102). For example, the graphical user interface of a mobile application may include a “yield” button that the user 102 may press on a touchscreen instance of the display 605 to generate the attenuation instruction 612. The attenuation instruction 612 may be transmitted over the network 101 to the coordination server 200 where it may be processed by the format allocation routine 208 to adjust the session format data 130, including for example adding time to the time allocation 136 of other segments 134 of the audio session. Alternatively, or in addition, the attenuation instruction 612 may be sent to the device 600 of the moderator user for review, approval, and/or modification. Similarly, an insertion request 614 may be generated that may be data specifying a request for additional time, an additional segment 134, and/or to be added to (e.g., allowed to be inserted into) a segment 134 originally assigned to a different user 102.

In one or more embodiments, a user 102 originally consuming an audio recording that is live may become a panelist user. For example, the user 102 may wish to contribute to the audio recording and make an insertion request 614 through the user interface. This mode may be especially useful for public hearings, townhall events, and other sessions with potential audience participation, and may even give rise to important high-value and/or insightful content. It should be apparent that within an audio recording and/or distribution platform, the users 102 may have varying levels of participation as a moderator, panelist, and/or consumer on a sliding scale which may change over time, according to one or more embodiments. Technology supporting a user 102′s ability to contribute, participate, and/or have insights attributed to that user 102, may further enhance the participation, value, and insight of the platform, according to one or more embodiments.

A number of process flows will now be described. It should be noted that the logic flows depicted in the figures do not require the particular order shown, or sequential order, to achieve desirable results. In addition, other steps and/or operations may be provided and/or eliminated.

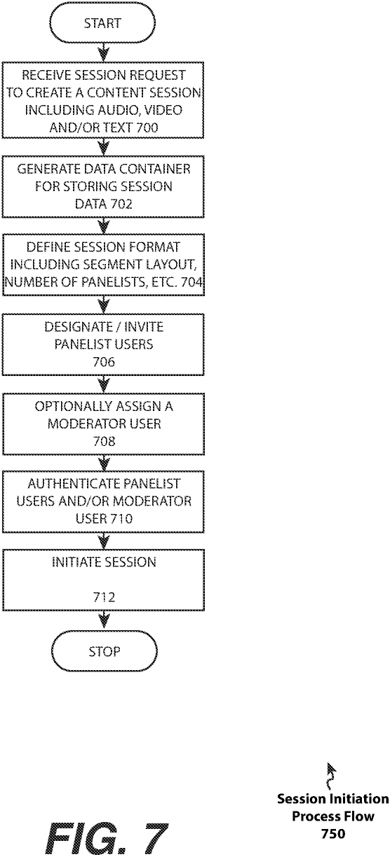

FIG. 7 illustrates a session initiation process flow 750, according to one or more embodiments. Operation 700 receives a session request (e.g., a session request 205) to create a content session, where a generated content could include audio, video, and/or text. For example, the content session may be primarily for generating an audio recording, a video recording in addition to an audio record, and/or for generating text. In one or more embodiments, the content session may be solely an audio session. In one or more embodiments, as described further below, there may even be a “text session” in which the primary content generated may be written text. Operation 702 generates a data container 120 for storing session data. The session data may be able to accommodate any of the data illustrated as stored within and/or in association with the data container 120, for example as shown and described in conjunction with the embodiment of FIG. 1.4. Operation 704 defines a session format including a segment layout, a number of panelists, etc. For example, operation 704 may define the session format data 130 of FIG. 1.4, including for example the panelist number 131, the panelist criteria 132, and/or the segment format 133. A segment layout may include an arrangement of segments (e.g., a set of ‘N’ segments 134A through segments 134N) and an amount of time (e.g., a time allocation 136 for each) and/or other resources or permissions for each session. For example, some sessions may permit the addition of visuals, video, audience requests for participation, etc. Following designation of segments, a segment data 110 may be initialized, stored, and/or associated for each segment 134. Alternatively, in one or more embodiments, the segment data 110 may be stored directly in the container data 120 and there may be no discrete data objects for the segment data 110.

Operation 706 designates and/or invites at least one panelist user (e.g., a user 102 acting as a panelist) to each segment. For example, a user 102 setting up the session may select panelists from a contact list, may run a search for panelists to invite based on data of user profiles 160 of potential panelists, and/or may open the session to application for panelist inclusion or participation. Operation 708 optionally assigns a moderator user. For example, the moderator user may be a debate moderator, a host, and/or another mediator of the content session. The moderator user may have special permission with respect to the session, for example changing the session format (including dynamically changing the session format data 140 during the content session), approving requests from panelists and/or live audience, and similar functions. It should be noted that multiple moderator users may be specified, for example allocating certain functions or responsibilities. As just one example, a first moderator may be granted permission to dynamically modify the session format, whereas a second moderator may be a primary host asking questions and facilitating conversation among panelists.

Operation 710 authenticates a panelist user and/or moderator user. The authentication may occur following an invitation and/or prior to initiation of the content session. In one or more embodiments, the authentication system 202 may authenticate the user 102, as described in conjunction with the embodiment of FIG. 2. For a synchronous and/or live content session, it may be determined that all contributing users 102 (e.g., panelists and/or moderators) are present, connected over a network 101 (e.g., has a stable connection on the device 600), and other preparatory functions have been met. Operation 712 may then initiate the content session and begin receiving content data, such as video, audio, image, textual, and/or other multimedia data.

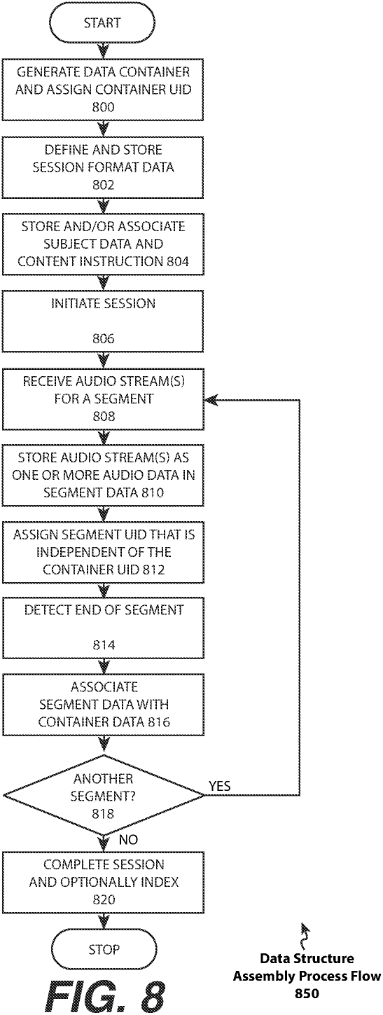

FIG. 8 is a data structure assembly process flow 850, according to one or more embodiments. Operation 800 generates a data container 120 and assigns a container UID 121. The data container 120 may be a data object generated in a wide variety of data models, for example an node of a graph database, a row and/or table of a relational database, an entity-attribute-value data structure, and/or a key value store. Example commercial database that may be utilized to store the data container 120 and/or other data objects described herein include: MySQL, PostgreSQL, Oracle, MongoDB, Reddis, FoundationDB, and/or NodeJS. Operation 802 defines and stores a session format data 130. The session format data 130 may include data that defines a content session, for example an audio session, including the length, content, participation, and/or other rules related to each segment and the overall session. A template format may also be selected and stored and/or referenced by operation 802. Operation 804 stores and/or associates a subject data 150 and/or content instruction data 125 may be stored or referenced. In one or more embodiments, multiple instances of the subject data 150 and/or content instruction data 125. In one or more embodiments, each segment may have a different or supplemental subject data 150 and/or content instruction data 125, where the data container 120 may inherit the subject data 150 and/or content instruction data 125 from each segment data 110 to which it is associated.

Operation 806 may initiate an audio session. In one or more other embodiments, operation 806 may initiate a content session of a different type (e.g., video, multimedia, text, pictorial). Operation 808 receives one or more audio streams 104 with respect to a segment, for example audio streams 104 from each device 600 of each user 102 specified to contribute to the session through reference to the associated user profiles 160. In one or more embodiments, especially in asynchronous sessions, an audio data 105 may be received instead. Operation 810 stores the one or more audio streams 104 as one or more instances of audio data 105 within a segment data 110. The segment data 110 may be initialized and stored concurrently with the initiation of the segment, or may be preassembled at the time of session formatting. Operation 812 assigns a segment UID 111 to the segment data 110 that is independent of the container UID 121. As a result, in one or more embodiments, the segment data 110 may be individually addressed by a query and/or referenced by other data objects within or external to a content database 310.

Operation 814 detects the end of a segment (e.g., a segment 134). The segment may end naturally (e.g., at the end of the time allocation 136), may end automatically due to occurrence of an adverse condition (e.g., a connection issue occurring with a device 600), and/or related to instructions of one or more users 102 (e.g., the panelist yielding time, the moderator terminating the session). Operation 816 associates the segment data 110 with the container data 120. A database reference linking the segment data 110 and the container data 120 may be a one-way pointer or a two-way pointer within the data structure, where each may reference the other using a unique identifier.

Operation 818 determines whether an additional segment is specified. If an additional segment is specified (e.g., in the session format data 130), operation 818 returns to operation 808. Otherwise, if no additional segments are specified, operation 818 proceeds to operation 820. Operation 820 completes the session, solidifies and/or commits storage of the data container 120 and each associated session data 110, and/or optionally indexes the content.

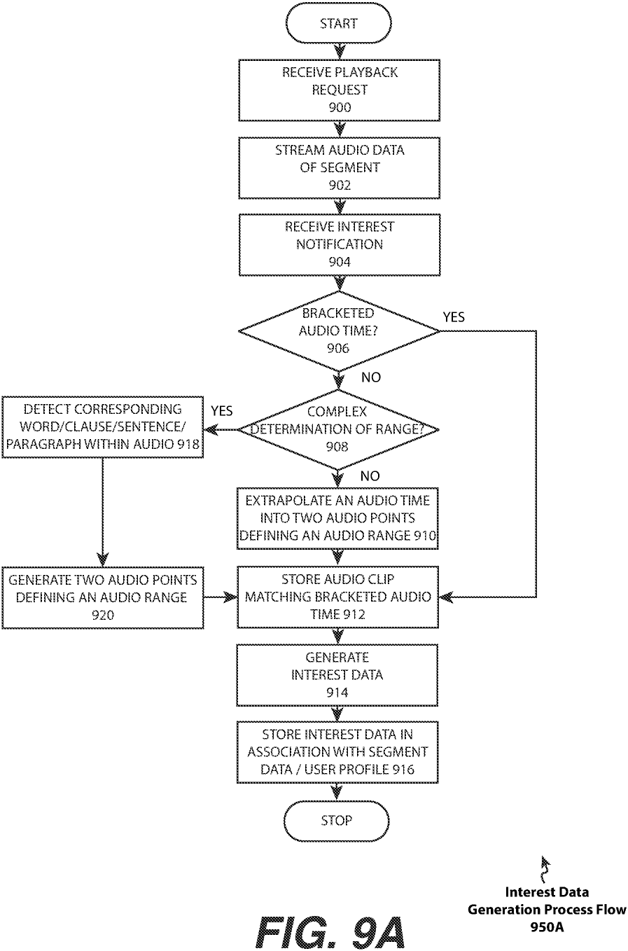

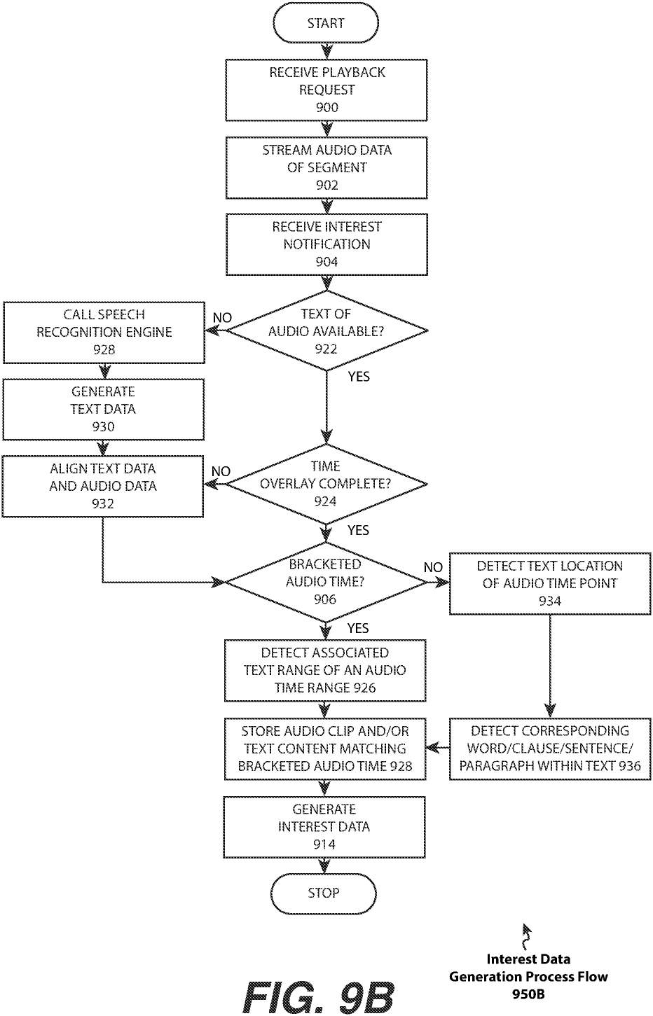

FIG. 9A illustrates an interest data generation process flow 950A, according to one or more embodiments. Operation 900 receives a playback request for an audio recording. The playback request may be generated by the device 600 of a user 106, for example when a user 102 selects a content item (e.g., from a thumbnail and description) from a menu. Operation 902 streams an audio data 105 of the segment data 110 associated with the selection. Where the user 102 may have selected an icon representing a recorded audio session as stored in a data container 120, playback may be initiated for a session data 110 indexed in a first position within the session format data 130. The device 600 and/or a software application on the device (e.g., the playback application 602) may play the audio data 105 for the user 102.

Operation 904 may receive an interest notification 107 from the device 600 of the user 102 over the network 101. The interest notification may have a variety of formats. In one or more embodiment, a single instance of an audio time may be transmitted along with the segment UID 111. In one or more other embodiments, a bracketed audio time and/or time range may be transmitted, which may include a first audio time point for a start of content of interest to the user 102 and a second audio time for an end to the content of interest.

Operation 906 determines whether the interest notification 107 includes a bracketed audio time. Where a bracketed audio time is available, operation 906 proceeds to operation 912. Operation 912 stores an audio clip 145 matching the bracketed audio time. The audio clip 145 may be referenced through the bracketed times (e.g., for minutes, seconds, milliseconds, a time range from 00:44:311 to 00:48:671) and/or may extract and copy a portion of the audio data 105. Operation 914 generates an interest data 108, and may store the audio clip 145 in association with the interest data 108. Operation 916 then stores the interest data 108 in association with the segment data 110 and/or the user profile 160 of the user 102 initiating the interest notification 107.

Where no bracketed audio time is received along with the interest notification 107, operation 906 may proceed to operation 908. Operation 908 may determine whether a complex determination of an audio time range should occur. If no complex determination of an audio time range is to occur, operation 908 proceeds to operation 910, which may extrapolate a single audio time point into two audio time points defining an audio time range. For example, in one or more embodiments, two audio time points may be extended equidistant from the single time point (e.g., five seconds in either direction), may be extended asymmetrically (e.g., 3 seconds back, 7 seconds forward), and/or may be extended in one direction (e.g., 10 seconds before the single audio time point). Operation 910 may then proceed to operation 912.

If a complex determination of a range is to occur, operation 908 may proceed to operation 918. Operation 918 detect a corresponding word, phrase, clause, sentence, and/or paragraph in which the single time point occurs. Numerous methods are possible. However, in one or more embodiments waveform analysis may determine a cutoff point likely to match a word, phrase, clause, sentence, and/or paragraph, including assessing waveform gaps, changes in tone, and/or utilizing voice recognition to determine a different speaker. Alternatively, or in addition, text alignment through speech recognition may be utilized, as shown and described in conjunction with the embodiment of FIG. 9B. Upon determination of a corresponding word, phrase, clause, sentence, and/or paragraph, operation 920 may determine two audio time points, a first audio time point and a second audio time point defining the range of the corresponding word, phrase, clause, sentence, and/or paragraph to be stored and/or referenced. Operation 920 may then proceed to operation 912. Following operation 912, operation 914 may generate the interest data 108, for example including and/or associated with one or more elements of data as illustrated in FIG. 5. Operation 916 then stores the interest data 108 in association with the segment data 100 and/or user profile 160.

FIG. 9B illustrates another interest data generation process flow 950B, according to one or more embodiments. Operation 900 through operation 904 occur as described in the embodiment of FIG. 9A, except that upon completion operation 904 may proceed to operation 922. Operation 922 may determine whether a text (e.g., the text data 116) of the audio (e.g., the audio data 105) is available. For example, a query may be made to the segment data 110 to determine whether a text data 110 has been stored. If text is available, operation 922 may proceed to operation 924 which may determine if a time overlay has been completed. For example, it may be determined whether data linking locations in the text data 116 and the audio data 105 have been determined and/or stored. Where a time overlay has been completed, operation 924 may proceed to operation 906, which may function as described in conjunction with the embodiment of FIG. 9B. Where a bracketed audio time is available, operation 906 may proceed to operation 926 which may detect a text range associated with an audio time range specified by the bracketed audio time. The time overlay may be utilized to determine a text location corresponding to the first audio time point and a second text location corresponding to the second audio time point. For example, in the sentence “Look on my Works, ye Mighty, and despair,” the “L” is character location number one and the ending period is character location number forty). Word, sound, or syllable locations also or alternatively may be mapped. Operation 928 may then store an audio clip (e.g., an audio clip 145) and/or a text content (e.g., the text content 146). Operation 928 may then proceed to operation 914, which may function as described in the embodiment of FIG. 9B.

Where no text is available as determined by operation 922, operation 922 may proceed to operation 928 which may call a speech recognition system (e.g., the speech recognition software 402). Operation 930 may then generate text from the audio recording, for example generating the text data 116 from the audio data 105, and proceed to operation 932. In addition, where no time overlay is complete, operation 924 may proceed to operation 932. Operation 932 aligns the text and audio, for example by determining a set of times within the audio data 105 aligned to each text location (e.g., word locations and/or character locations) within the text data 116. Where metadata establishes the alignment from operation 930, the metadata may be saved in association with the audio data 105 and/or text data 116. Operation 932 may then proceed to operation 906.

Where no bracketed audio time is determined to be present (e.g., a single audio time point is included in the interest notification 107), operation 906 may proceed to operation 934 which may detect a text location of the audio time point. Operation 936 may then detect a corresponding word, clause, phrase, sentence, and/or paragraph associated with the text location. For example, the sentence in which the text location occurs, and a sentence on either side of the sentence in which the text location occurs. In one or more embodiments, a first character location may be established at the start of a range, and a second character location at an end of this range. Operation 936 may then proceed to operation 928, with that optional modification that operation 928 may store an audio clip 145 associated with the first text location and the second text location, and further that operation 928 may store the text content (e.g., the text content 146) matching the range designated by the first text location and the second text location as may be determined in operation 936. Operation 928 may then proceed to operation 914 which may generate the interest data 108 as similarly described in FIG. 9B.

FIG. 10 illustrates an insight data generation process flow 1050, according to one or more embodiments. Operation 1000 may detect one or more interest data 108 associated with a segment data 110 and/or portion of a segment data 110. For example, each interest data 108 stored in association with a user profile 160 that references an instance of the segment data 110 may be logged at the time the interest data 108 is generated, and/or may be copied into a separate database. Alternatively, or in addition, it should be noted that other interactions of a user 102 with a segment data 110 may be usable to derive high value content. For example, such interactions may indicate high value content where multiple users 102 pause and re-listen to a portion of an audio data 105, where a user 102 shares a portion and/or audio time point with another user 102, and/or demonstrate other interactions with the audio data 105 and/or text data 116.

Operation 1002 may determine whether a number of interest data 108 associated with the segment data 110 and/or a number of interest data 108 referencing a portion of the audio data 105 and/or text data 116 exceeds a threshold interest value. For example, in one or more embodiments there may be a threshold number of interest data 108 that must be defined with respect to an instance of the segment data 110 before such interest will be evaluated for occurrence and/or boundaries of what may be high-value content (e.g., 10, 100, or 1000) instances of the interest data 109. In another example, ten instances of the interest data 108 may have to be defined within a quartile of an audio data 105, or within a same paragraph of a text data 116. In one or more embodiments, quality of the interest may also be evaluated. For example, an interest data 110 in which the user 102 may have taken time to bracket an audio time, add tags, or take notes may be of higher value than a single audio time point (in such case that the software application allowing selection supports both). Similarly, a user characteristic of a user 102 providing the interest notification 107 resulting in the interest data 108 may also be weighted (e.g., a user with a technical background being given more weight for a segment data 110 having technical content - or vice versa where more general publicly accessible insight is sought to be “mined” from otherwise dense technical conversation). Where the threshold interest value is not exceeded, operation 1002 returns to operation 1000. Where the threshold value is exceeded, operation 1002 proceeds to operation 1004.

Operation 1004 applies a statistical function, for example to determine a probability that two or more interest data 108 are related and/or point to what may be related high value content. For example, the statistical function may minimize the mean square error of a test audio time point relative to audio time points identified in each interest data 108. The test audio time point may be initially approximated and then moved randomly and/or through Monte Carlo methods. A similar technique may be utilized in which mean square error may be minimized for a test text location and/or a test character location relative to text locations identified in each interest data 108. Similarly, in one or more embodiments, a first test audio time point may be used for a start time of high value content and a second test audio time point may be used for an end time of high value content. Other statistical functions and/or operations will be evident to one skilled in the art of statistics and/or computer science. Test audio time points and/or test text locations may be selected based on what may be natural breaks, such as pauses in audio recordings, punctuation within text, etc.

Operation 1006 determines whether the statistical function is within a statistical model boundary, such as a quality, error, and/or fit boundary. For example, where output of the statistical function returns a high value for the average mean square error then a fit may be poor and no high value content may be identifiable. Operation 1006 may then return to operation 1000, possibly to wait for additional data. Alternatively, although not shown in the embodiment of FIG. 10, operation 1006 may return to operation 1004 to adjust parameters and/or attempt additional statistical functions. Where the output of the statistical function is within a statistical model boundary, operation 1006 may proceed to operation 1010, which may determine whether a portion of the audio data 105 and/or the text content 116 that is the proposed insight data matches an audio clip 145 and/or a text content 146 of an existing insight data 140. Matches may be determined through overlap detection (e.g., eighty percent overlap may determine a match). Where a match is detected, the high value content and/or insight may already have been determined, and operation 1010 may proceed to operation 1011 to discard the proposed insight data 140. Alternatively, or in addition, the preexisting instance of the insight data 140 may be re-evaluated with new instances of the insight data 140. Such re-evaluation may enable “honing in” on and/or continual improvement in identifying the high value content. For example, as additional instances of the interest data 108 are defined, the starting audio time point and the ending audio time point of the audio clip 145 of an insight data 140 may be adjusted and become increasingly accurate to describe what is probabilistically high-value content for a large population of users 102 consuming audio recordings.

In the event no existing match occurs in operation 1010, then operation 1010 may proceed to operation 1012 which may determine if text of the audio is available (e.g., a text data 116 of the audio data 105). If no text is available, operation 1012 may proceed to operation 1013 which may generate an insight data 140 comprising an audio clip 145. The insight data 140 may store a first audio time point and a second audio time point defining the audio clip 145. Where text of the audio is available, the insight data 140 may be generated comprising a text content 146. The text content 146 may be defined by a first character location and a second character location bracketing the text content 146. Alternatively, or in addition, the insight data 140 may be generated with both an audio clip 145 and a text content 146. Operation 1016 then stores the insight data 140 in association with the segment data 110 and/or the user profile 160 of one or more users 102 who contributed to the segment data 110 from which the insight data 140 derives (e.g., panelist users and/or moderator users).

An insight data 140 may be used for a wide variety of purposes. In one or more embodiments, the insight data 140 may be used to provide highlights and/or summary versions of an audio recording and/or text transcript. In one or more embodiments, the insight data 140 may form a separate indexable database to help locate relevant content in response to user 102 searches (e.g., indexed in the insight data index 334). In one or more embodiments, the insight data 140 may be used to recommend content to a user 102 for consumption. For example, a container data 120 and/or segment data 130 having may be recommended to a user 102, where an insight data 140 associated with the segment data 130 shares similar audio and/or text to the audio and/or text identified in an interest data 108 the user 102 stores related to a different segment data 130. In one or more embodiment, the insight data 140 may be used for determining new trends, developing attitudes of a demographic, for product or brand recognition, and for scientific and/or political research. In one or more embodiments, the insight data 140 may be sponsored, linked to advertisements, and/or trigger sponsored content as determined by a general audience or certain demographic. For example, a sponsor may for a limited time be able to exclusively utilize a phrase identified in an insight data 140. In one or more embodiments, the insight data 108 may be used to help content creators (e.g., mediators, panelists, session sponsors and/or session creators) to determine their most high value and/or insightful content. For example, a user 102 may be able to log into their use profile 160 and see all insight data 140 that has been derived from each segment data 110 to which the user 102 contributed. In one or more embodiments, the insight data 140 may be used as a factor in generating recombinant instances of the data container 120, as further described below. For example, a recombinant instance of the data container 120 could be built to ensure a variety of unrelated insight and/or high value content is used such that each segment data 110 remains a rich experience for a consuming instance of the user 102.

However, and without limiting the previous examples, in one or more embodiments, the insight data 140 may act as distinct content to be utilized by other systems or server. For example, each insight data 140 may receive a unique identifier (e.g., the insight UID 144) and may be individually addressed and/or called by an application, server, or system. As just one example, the insight data 140, and/or the associated audio clip 145 and/or text content 146, may be forwarded to a server of a social network (e.g., Facebook®, LinkedIn®, Tiktok®, Instagram®, Twitter®). For instance, a social network and/or any website or online service with a viewable profile, may enable hosting and/or automatic display of the most insightful audio or text. The posting or display may occur on the social media profile of the user 102.The insightful audio and/or text may be retrievable through API (e.g., the extraction content API 324).

FIG. 11 illustrates an insight extraction and access process flow, according to one or more embodiments. Operation 1100 extracts a first text content 146A of an insight data 140. For example a query may be made to the insight UID 144 and the text content 146 read and copied. Operation 1102 authorizes access through an API (e.g., the extraction content API 324) to the first text content 146A of the insight data 140, the access granted through an API key controlled by a user 102, where optionally the user 102 generated an audio data 105 that when submitted to a speech recognition software 402 resulted in a text data 116 of which the text content 146 is included. For instance, part of the use profile 160 of the user 102 may be usable to control the API key, whether or not the user 102 has directed access to the API key. In another example, a message, a post, and/or a “tweet” (in the case of Twitter®) may be generated using the insight data 140. The user 102 may be able to, and/or may be required to, review the insight data 140 (e.g., on the device 600) prior to any automated communication. The user 102 may have the ability to control the call for insight data 140 to which the user 102 contributed. Operation 1104 responds to a remote procedure call from a social media server by transmitting the first text content 146A and/or pushing the first text content 146A to social media server. As described above, this may be useful for attributing insights of a user 102 to that user 102 on a different platform (including insights and/or high value content identified by third parties and/or other users 102 acting as consumers of content through generation of the interest data 108). Another example of such use may be the livestreaming of insights that may be generated in real time or near real time during events such as conferences, live in-person panels, etc.

In one or more embodiments, the insight data 140 may be updated as more data becomes available for analysis (e.g., more instances of the interest data 108). Operation 1406 may dynamically update the insight data 140 upon receiving an interest marker 108 and determining above the threshold probability that a set of interest markers 108 are directed to a second text content 146B of the text data 116. The second text content 146B, for example, may have an adjusted text location point designating a start and/or an end of the high value content, may have an expanded range of text within the text data 116, and/or have a reduced range of text within the text data 116. Various rules may be defined to delineate a new insight data 140 from redesignation/refinement of an existing insight data 140.

FIG. 12 illustrates a recombinant audio process flow 1250, according to one or more embodiments. Operation 1200 queries a content database (e.g., the content database 310) for one or more data containers 210 that each include at least one of a similar content instruction data 125 and/or a similar subject data 150. Other common characteristics are also possible to determine, including similarity of interest data 108 and/or insight data 140. Operation 1202 returns the container UID 121A of Aa first data container 120A and a container UID 121B of a second data container 120B. Operation 1204 extracts a first segment UID 111A of a first segment data 110A from a set of segment data 110 of the first data container 120A. Operation 1206 extracts a second segment UID 111B of a second segment data 110B from the second data container 120B. Operation 1208 then assemble a third data container 120C (e.g., a recombinant instance) that includes: (i) the content instruction data 125 and/or the subject data 150, (ii) a segment UID 111A of the first segment data 110A, and (iii) the segment UID 111B of the second segment data 110B. In one or more embodiments, the result may be to generate a podcast file (e.g., a series of audio data 105 from each segment 110) with new opportunities for comparative insight and analysis (e.g., for a user 102 acting as a consumer of audio recordings and/or text transcripts).

FIG. 13 illustrates an example of the use of the structured audio data network 100 and additional aspects of the various embodiments. In the example embodiment of FIG. 13, an audio session is initiated with a first user 102A (acting as a moderator), a second user 102B (acting as a first panelist), and a third user 102C (acting as a second panelist). The user 102A may initially generate a request to set up an audio session that defines several segments that are each assigned to the user 102A, the user 102B, and/or the user 102C.

Specifically, in the present embodiment, from left to right: a first two-minute segment may be assigned to the user 102A with the instruction that the user 102A can introduce the user 102B and the user 102C. The second segment may also be two minutes, and may be assigned to the user 102B for the user 102B to make an opening statement. The third segment also may be two minutes, and may be assigned to the user 102C for the user 102C to make an opening statement. The fourth segment may be six minutes and may be assigned to both the user 102B and the user 102A, with the intent that the moderator asks questions of the first panelist. The fifth segment may also be six minutes, and may be assigned to the user 102C and the user 102A, where the moderator similarly asks questions of the second panelist. The sixth segment may last ten minutes, where the user 102A may ask questions that either the user 102B or the user 102C may answer. Finally, the seventh segment may last two minutes, and may comprise a closing statement by the user 102A.

As illustrated in FIG. 1.4, the user 102A may generate the request using the device 600A. In response a server (e.g., the coordination server 200) may generate a data container 120 with a session format data 130 specifying seven instances of the segment 134 (e.g., the segments 134A through the segment 134G), each having a time allocation 136 (e.g., a time allocation 136 equal to two minutes, two minutes, two minutes, six minutes, six minutes, ten minutes, and two minutes, respectively). Each segment 134 defined in the configuration process and/or dynamically created during an audio session may initiate setup of a separate instance of a segment data 110.

The user 102A, the user 102B, and the user 102C may then each record their designated audio recordings in a managed audio session. For example, the segment data 110A may store an audio data 105A generated by the user 102A. Similarly, the segment data 110D may store a first audio data 105D.1 from the user 102B and a second audio data 105D.2 from the user 102C, which may or may not be compressed and/or combined upon storage (e.g., compressed into an audio file 114). As shown and described herein, a transcript may be generated from one or more instances of audio data 105 and/or the audio file 114, the transcript referred to here as the text data 116D.

Once audio recording and/or the transcript of the audio session available for consumption, a user 102X and a user 102Y may select the data container 120. The selection may occur by name (e.g., the title data 127) or thumbnail within a menu on a user interface. The audio data 105D and the text data 116D of the segment data 110D may be streamed over the network 101 to the device 600X of the user 102X. While listening to the audio recording, the user 102X may hear a section that the user 102X feels is interesting or valuable.

In the present example, a famous speech about space is used for illustration of a high-value quote and/or insight due to its familiarity in what has become an iconic phrase. In the present fictional example, the content of the speech would have been spoken by the user 102B who was the panelist in the segment data 110D. The user 102X may place a first audio time point 167A.1 at a first time and a second audio time point 167A.2 at a second time, bracketing the audio range for: “not because they are easy, but because they are hard, because that goal will serve to organize and measure the best of our energies and skills, because that challenge is one that we are willing to accept”. The user 102X may alternatively have selected a text location 169A.1 beginning with “not” and ending with the text location 169A.2 “accept.” The user 102X may generate an interest notification 107 that includes the first audio time point 167A.1, the second audio time point 167A.2, the unique identifier of the segment (e.g., the segment UID 111), and the user UID 161 of the user 102X. The interest notification 107 of the user 102X may be received and stored as an interest data 108X in association with the user profile 160 of the user 102X (not shown).

Similarly, the user 102Y may stream and/or download the audio data 105D and the text data 116D. The user 102Y may select the audio and/or text for: “Why does Rice play Texas? We choose to go to the moon. We choose to go to the moon in this decade and do the other things, not because they are easy”. The selection may be made by the user 102Y through defining the audio time point 167B.1 and the audio time point 167B.2 and/or by selection of the text location 169B.1 and the text location 169B.2. Alternatively, or in addition, as described herein, the audio time point 167B.1 may be determined from the text location 169B.1 and the audio time point 167B.2 may be determined from the text location 169B.2 (or text locations 169 may be determined from audio time points 167). An interest notification 107 of the user 102Y may be similarly generated and stored as an interest data 108Y in association with the user profile 160 of the user 102Y.

A simple example of generation of an insight data 140 will now be illustrated. While only two instances of the interest data 108 will be used for ease of illustration, it will be appreciated that tens, hundreds, thousands, or more interest data 108 and/or other interactions of user 102 may be utilized in generating one or more instances of the insight data 140.

Generation of the interest data 108X and the interest data 108Y may indicate substantial interest in a similar segment data 110. The interest data 108X and the interest data 108Y may be analyzed to determine probabilistically high value continent. Specifically, in the present example, an overlap of audio data 105D and/or text data 116D selected by the audio time point 167A.1, the audio time point 167A.2, the audio time point 167B.1, and the audio time point 167B.2 is: “We choose to go to the moon in this decade and do the other things, not because they are east, but because they are hard.” This high value content may be referenced and/or stored as the audio clip 145 and/or the text content 146 of an insight data 140. The insight data 140 may be stored in association with the segment data 110, including assignment of an insight UID 144.

Once generated, the insight data 140 may be associated with the user profile 160B of the user 102B who was recorded in the audio data 105D. The insight data 140 may then be used for a variety of purposes described herein, including locating relevant audio recordings through search, assisting with data analysis and marketing intelligence, enhancing social media promotion of the user 102B, and/or building the most insightful and popular recombinant instances of the data container 120 (e.g., a “synthetic session”).

While many of the examples used herein discuss audio sessions, and describe conversion of audio to text, it should be noted that the opposite is possible. In one or more embodiments, the session may be a “text session” where the user 102 may primarily contribute text (e.g., a text data 116) which may then be converted into speech, either by the user 102 reading the text and/or an automated voice with text-to-speech capability. Mixed sessions are also possible, for example enabling a user 102 who is deaf and/or mute to more easily participate, including in real time and/or near real time.

Although the present embodiments have been described with reference to specific example embodiments, it will be evident that various modifications and changes may be made to these embodiments without departing from the broader spirit and scope of the various embodiments. For example, the various devices, engines, agent, routines, and modules described herein may be enabled and operated using hardware circuitry (e.g., CMOS based logic circuitry), firmware, software, or any combination of hardware, firmware, and software (e.g., embodied in a non-transitory machine-readable medium). For example, the various electrical structure and methods may be embodied using transistors, logic gates, and electrical circuits (e.g., application specific integrated circuitry (ASIC) and/or Digital Signal Processor (DSP) circuitry).

In addition, it will be appreciated that the various operations, processes, and methods disclosed herein may be embodied in a non-transitory machine-readable medium and/or a machine-accessible medium compatible with a data processing system (e.g., the coordination server 200, the database server 300, the analytics server 400, the profile server 500, the device 600, the social media server, and/or other servers and computers). Accordingly, the specification and drawings are to be regarded in an illustrative rather than a restrictive sense.

The structures in the figures such as the engines, routines, and modules may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the preceding disclosure.

Embodiments of the invention are discussed above with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures.

From reading the present disclosure, other variations and modifications will be apparent to persons skilled in the art. Such variations and modifications may involve equivalent and other features which are already known in the art, and which may be used instead of or in addition to features already described herein.

Although claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any claim and whether or not it mitigates any or all of the same technical problems.

Features which are described in the context of separate embodiments may also be provided in combination in a single embodiment. Conversely, various features which are, for brevity, described in the context of a single embodiment, may also be provided separately or in any suitable sub-combination. The applicants hereby give notice that new claims may be formulated to such features and/or combinations of such features during the prosecution of the present application or of any further application derived therefrom.

References to “one embodiment,” “an embodiment,” “example embodiment,” “various embodiments,” “one or more embodiments,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least one or more embodiments of the invention” includes the stated particular feature, structure, or characteristic.

The enumerated listing of items does not imply that any or all of the items are mutually exclusive, unless expressly specified otherwise.

It is understood that the use of a specific component, device and/or parameter names are for example only and not meant to imply any limitations on the invention. The invention may thus be implemented with different nomenclature and/or terminology utilized to describe the mechanisms, units, structures, components, devices, parameters and/or elements herein, without limitation. Each term utilized herein is to be given its broadest interpretation given the context in which that term is utilized.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; a smartphone, application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, one or more embodiments of the disclosure may be practiced in network computing environments with many types of computer system configurations, including personal computers, hand-held devices, multiprocessor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java.TM., Jini.TM., C, C++, Smalltalk, Perl, UNIX Shell, Visual Basic or Visual Basic Script, Virtual Reality Markup Language (VRML), ColdFusion.TM. or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system’s registers and/or memories into other data similarly represented as physical quantities within the computing system’s memories, registers or other such information storage, transmission or display devices.

The term “processor” may refer to any device or portion of a device that processes electronic data from registers and/or memory to transform that electronic data into other electronic data that may be stored in registers and/or memory. A “computing platform” may comprise one or more processors.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of implementing the certification network 100 according to the present invention will be apparent to those skilled in the art. Various aspects of the invention have been described above by way of illustration, and the specific embodiments disclosed are not intended to limit the invention to the particular forms disclosed. The particular implementation of the loyalty rewards programs may vary depending upon the particular context or application. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

We claim:

1. A method for structuring audio recordings for identification of high value content, the method comprising:
generating in a computer readable memory a data container for storing data of an audio session;
assigning a container UID to the data container;
authenticating a first user associated with a first user profile and a second user associated with a second user profile;
receiving a first audio data from a device of the first user over a network,
storing the first audio data in a first segment data,
assigning a first segment UID to the first segment data that is independently addressable from the container UID with a database query;
receiving a second audio data from a device of the second user over the network,
storing the second audio data in a second segment data,
assigning a second segment UID to the second segment data that is independently addressable from the container UID and the first segment UID of the first segment data with the database query; and
associating both the first segment data with the data container through a first reference attribute and the second segment data with the data container through a second reference attribute.

2. The method of claim 1, further comprising:
applying a speech recognition software to the first segment data to generate a text data;
associating the text data with the first segment data; and
mapping an audio time point of the first audio data to a text location within the text data.

3. The method of claim 1, further comprising:
receiving a playback request from a device of a third user comprising at least one of the container UID of the data container and the first segment UID of the first segment data;
streaming at least one of the first audio data of the first segment data and the text data of the first segment data to the device of the third user;
receiving a first interest notification from the device of the third user comprising the first segment UID of the first segment data, a first audio time point and a second audio time point;
generating a first interest marker comprising the first segment UID of the first segment data, the first audio time point, and the second audio time point; and
storing the first interest marker in association with the user UID of the third user, and optionally at least one of the container UID of the data container, the first segment UID of the first segment data, and the user UID of a fourth user generating the first audio data.

4. The method of claim 2, further comprising:
receiving a first interest notification from a device of a third user comprising the first segment UID of the first segment data and at least one of an audio time point and an audio time range;
determining a first text content that is at least one of a word, a phrase, and a sentence within the text data that corresponds to the at least one of the audio time point and the audio time range;
generating an interest marker specifying the first text content; and
storing the interest marker in association with a user UID of the third user, and optionally at least one of the container UID of the data container, the container UID of the first segment data, and a user UID of a fourth user generating the first audio data.

5. The method of claim 3, further comprising:
generating a second interest marker from a second interest notification received from a device of a fifth user having generated a second playback request;
determining above a threshold probability that the first interest marker and the second interest marker associated with a second text content are both directed to a third text content that is at least partially outside at least one of a first text content and the second text content;
generating an insight data to specify the third text content,
wherein the insight data comprising at least one of the third text content, data specifying a text location of the third text content within a text data, a portion of the first audio data, and data specifying an audio location of an audio clip within the first audio data of the first segment data; and
storing the insight data in association with at least one of the container UID of the data container and the first segment UID of the first segment data.

6. The method of claim 5, further comprising:
extracting the third text content of the insight data;
authorizing access through the API to the third text content of the insight data by a an API key controlled by the first user;
responding to a remote procedure call from a social media network by transmitting the first text content;
dynamically updating the insight data upon receiving a third interest marker and determining above the threshold probability that the first interest marker, the second interest marker, and the third interest marker are directed to a fourth text content;
receiving a selection of a content instruction for generating the first audio data,
wherein the content instruction is a text string comprising at least one of a discussion topic, a debate motion, and a discussion prompt;
associating the content instruction with the data container and indexing the content instruction in a database;
storing a time overlay of the text data in association with the first segment data, wherein at least two characters of the text data associated with at least two audio time points of the first segment data;
receiving a subject designation from at least one of the first user and the second user; and
associating a subject data with the data container.

7. A method for generating audio recordings for efficient content remixing:
receiving a session request for creation of an audio session from a device of a first user comprising a user UID of the first user and a content instruction for generating an audio recording for the audio session;
generating a first data container within a session database to receive data from the audio session and assigning a container UID to the first data container;
specifying a session format data comprising a panelist number, a panelist criteria, and a segment composition comprising a plurality of segments each having a time allocation;
designating a panelist role for a user profile of each of two or more users to define two or more panelist users;
assigning each of the two or more panelist users to at least one of the plurality of segments;
receiving a set of audio streams from the two or more panelist users for each of the plurality of segments; and
storing a set of audio data within a set of segment data each assigned a segment UID and each associated with the first data container through a reference attribute,
wherein the set of audio data comprising a first audio data.

8. The method of claim 7, further comprising:
querying the session database for one or more data containers comprising at least one of the content instruction and a subject data;
returning the container UID of the first data container and a container UID of a second data container;
extracting a first segment UID of a first segment data from the set of segment data of the first data container;
extracting a second segment UID of a second segment data from the second data container; and
assembling a third data container comprising: (i) at least one of the content instruction and the subject data, (ii) the first segment UID of first segment data, and (iii) the segment UID of the second segment data, to generate a podcast file with new opportunities for comparative insight and analysis.

9. The method of claim 8, further comprising:
designating a moderator role for a first user profile of the first user to define a moderator user.

10. The method of claim 9, further comprising:
receiving a segment attenuation instruction for a first audio stream of the set of audio streams, the segment attenuation instruction generated by at least one of the moderator user and a panelist user of the two or more panelist users; and
initiating storage of a second audio data generated from the set of audio streams in a second segment data.

11. The method of claim 9, further comprising:
dynamically reallocating the session format data through at least one of: changing the panelist number, adjusting the panelist criteria, adjusting the segment composition comprising, and adjusting the time allocation of one or more of the plurality of segments.

12. The method of claim 11, further comprising:
applying a speech recognition software to the first segment data to generate a text data;
associating the text data with the first segment data;
mapping an audio time point of the first audio data to a text location within the text data;
receiving a playback request from a device of a third user comprising at least one of the container UID of the first data container and the first segment UID of the first segment data; and
streaming at least one of the first audio data of the first segment data and the text data of the first segment data to the device of the third user.

13. The method of claim 12, further comprising:
receiving a first interest notification from the device of the third user comprising the segment UID of the first segment data and at least one of an audio time point and an audio time range;
determining a first text content that is at least one of a word, a phrase, and a sentence within the text data that corresponds to the at least one of the audio time point and the audio time range;
generating a first interest marker specifying the first text content;
storing the first interest marker in association with a user UID of the third user, and optionally at least one of the container UID of the first data container, the container UID of the first segment data, and a user UID of a fourth user generating the first audio data;
indexing the insight data in a database;
generating a second interest marker from a second interest notification received from a device of a fifth user having generated a second playback request;
determining above a threshold probability that the first interest marker and the second interest marker associated with a second text content are both directed to a third text content that is at least partially outside at least one of a text location of the first text content and a text location of the second text content;
generating an insight data to specify the third text content,
wherein the insight data comprising at least one of the third text content, data specifying a text location of the third text content in the text data, a portion of the first audio data, and data specifying an audio location of an audio clip within the first audio data of the first segment data; and
storing the insight data in association with at least one of the container UID of the first data container and the container UID of the first segment data.

14. A system for analyzing use of audio files to determine high value content, the system comprising:
a database server storing a data container,
wherein a data container comprising a container UID, a first segment data having a first segment UID and a second segment data having a second segment UID, the first segment data comprising a first audio data, where the first segment UID, the second segment UID, and the container UID are each independently addressable with a database query;
a coordination server comprising:
a processor,
a memory,
a playback manager comprising computer readable instructions that when executed:
(i) receive a playback request received from a device of a first user, the playback request comprising the container UID of the data container,
(ii) stream the first audio data of the first segment data to the device of the first user, and
an interest marker engine comprising computer readable instructions that when executed:
receive a first interest notification from the device of the first user comprising the first segment UID of the first segment data, a first audio time point and a second audio time point,
generate a first interest marker comprising the first segment UID of the first segment data, the first audio time point, and the second audio time point, and
store the first interest marker in association with a user UID of the first user; and
an analytics server comprising computer readable instructions that when executed:
generate an insight data from the first interest marker, and
store the insight data in association with at least one of the container UID of the data container, the first segment UID of the first segment data and the user UID of a second user generating an audio data of the first segment data;
a network communicatively coupling the coordination server to the database server and the analytics server.

15. The system of claim 14, wherein the interest marker engine comprising computer readable instructions that when executed generate a second interest marker from a second interest notification received from a device of a third user having generated a second playback request, and wherein the analytics server further comprising computer readable instructions that when executed:
determine above a threshold probability that the first interest marker and the second interest marker associated with a second text content are both directed to a third text content that is at least partially outside at least one of a first text content identified by the first interest marker and the second text content identified by the second interest marker;
generate an insight data to specify the third text content,
wherein the insight data comprising at least one of the third text content, data specifying a text location of the third text content within a text data, a portion of the first audio data, and data specifying an audio location within the first audio data of the first segment data; and
store the insight data in association with at least one of the container UID of the data container and the first segment UID of the first segment data.

16. The system of claim 15, wherein the coordination server further comprising:
an inter-content extraction routine comprising computer readable instructions that when executed:
extract the third text content of the insight data and associating the third text content with the data container,
authorize access through an API to the first text content of the first interest marker by an API key controlled by the first user,
respond to a remote procedure call from a social media network by transmitting the first text content, and
dynamically update the insight data upon receiving a third interest marker and determining above the threshold probability that the first interest marker, the second interest marker, and the third interest marker are directed to a fourth text content; and
an extraction content API.

17. The system of claim 16, wherein the analytics server further comprising:
an audio/text alignment engine comprising computer readable instructions that when executed store a time overlay of the text data in association with the first segment data, wherein at least two characters of the text data associated with at least two audio time points of the first segment data.

18. The system of claim 17, wherein the analytics server further comprising:
a session synthesis engine comprising computer readable instructions that when executed:
query a session database for one or more data containers comprising at least one of a content instruction and a subject data;
return the container UID of the data container and a container UID of a second data container;
extract the first segment UID of the first segment data from a set of segment data associated with the data container;
extract the second segment UID of the second segment data from the second data container; and
assemble a third data container comprising: (i) at least one of the content instruction and the subject data, (ii) the first segment UID of first segment data, and (iii) the second segment UID of the second segment data, to generate a podcast file with new opportunities for comparative insight and analysis.

19. The system of claim 18, wherein the database server further comprising:
a container management routine comprising computer readable instructions that when executed:
generate the data container for storing data of an audio session,
assign the container UID to the data container,
generate the first segment data,
assign the first segment UID to the first segment data that is independently addressable from the container UID with the database query,
generate the second segment data,
assign the second segment UID to the second segment data that is independently addressable from the container UID and the first segment UID of the first segment data with the database query; and
a segment association subroutine comprising computer readable instructions that when executed:
associate both the first segment data with the data container through a first reference attribute and the second segment data with the data container through a second reference attribute.

20. The system of claim 19, wherein the coordination server further comprising:
a session initiation module comprising computer readable instructions that when executed:
receive a session request for creation of the audio session from the device of the first user comprising the user UID of the first user and a content instruction for generating an audio recording for the audio session, and
generate the data container within the session database to receive data from the audio session and assigning the container UID to the data container;
a format allocation routine comprising computer readable instructions that when executed:
specify a session format data comprising a panelist number, a panelist criteria, and a segment composition comprising a plurality of segments each having a time allocation; and
a role allocation module comprising computer readable instructions that when executed:
designate a panelist role for a user profile of each of two or more users to define two or more panelist users, and
assign each of the two or more panelist users to at least one of the plurality of segments.
